(19) United States
(12) Patent Application Publication
(10) Pub. No.: US 2023/0361313 A1
(43) Pub. Date: Nov. 9, 2023

(54) ELECTRODE FOR POWER STORAGE DEVICES AND LITHIUM-ION SECONDARY BATTERY

(71) Applicant: TDK Corporation, Tokyo (JP)

(72) Inventors: Takuya AOKI, Tokyo (JP); Shuji HIGASHI, Tokyo (JP); Syuji TSUKAMOTO, Tokyo (JP); Keisuke TATSUZAKI, Tokyo (JP); Kosuke TANAKA, Tokyo (JP)

(73) Assignee: TDK Corporation, Tokyo (JP)

(21) Appl. No.: 17/634,391

(22) PCT Filed: Mar. 30, 2021
(86) PCT No.: PCT/JP2021/013638

§ 371 Date: Feb. 10, 2022

(51) Int. Cl. H01M 4/13; H01M 4/66; H01M 10/0525; H01M 4/70

(52) U.S. Cl. CPC H01M 4/70; H01M 4/13; H01M 4/661; H01M 10/0525; H01M 2004/021

(57) ABSTRACT

An electrode for power storage devices includes: a resin layer having a first surface and a second surface that is located on an opposite side from the first surface; a first electrically-conductive layer that is disposed on the first surface side of the resin layer; and a first layer of particles that is disposed on an opposite side of the first electrically-conductive layer from the resin layer. In a cross section parallel to a thickness direction of the resin layer, the first electrically-conductive layer has a first shape including a plurality of protrusions that are convexed toward the resin layer and a recess that is disposed between two adjacent protrusions among the plurality of protrusions. A distance H along the thickness direction from one of top points of the two adjacent protrusions to a bottom point of the recess is smaller than a thickness of the resin layer.

### TECHNICAL FIELD

The present disclosure relates to an electrode for power storage devices and a lithium-ion secondary battery.

### BACKGROUND ART

It has been proposed to use composite materials having metal layers on opposite surfaces of a resin film as a current collector of a secondary battery. The following Patent Documents 1 and 2 disclose an electrode for secondary batteries in which such composite materials are adopted for the current collector.

### CITATION LIST

### Patent Literature

[Patent Document 1] the specification of U.S. Pat. Application Publication No. 2020/0373584
[Patent Document 2] Japanese Laid-Open Patent Publication No. 2014-75191

### SUMMARY OF INVENTION

### Technical Problem

Further improvements in rate characteristics are desired in power storage devices such as lithium-ion secondary batteries.

An embodiment of the present disclosure provides an electrode for power storage devices that allows the rate characteristics of power storage devices to be improved.

### Solution to Problem

An electrode for power storage devices according to an embodiment of the present disclosure comprises: a resin layer having a first surface and a second surface that is located on an opposite side from the first surface; a first electrically-conductive layer that is disposed on the first surface side of the resin layer; and a first layer of particles that is disposed on an opposite side of the first electrically-conductive layer from the resin layer, wherein, in a cross section parallel to a thickness direction of the resin layer, the first electrically-conductive layer has a first shape including a plurality of protrusions that are convexed toward the resin layer and a recess that is disposed between two adjacent protrusions among the plurality of protrusions; and a distance H along the thickness direction from one of top points of the two adjacent protrusions to a bottom point of the recess is smaller than a thickness of the resin layer.

An electrode for power storage devices according to another embodiment of the present disclosure comprises: a resin layer having a first surface and a second surface that is located on an opposite side from the first surface; a first electrically-conductive layer that is disposed on the first surface side of the resin layer; and a first layer of particles that is disposed on an opposite side of the first electrically-conductive layer from the resin layer, wherein, in a cross section parallel to a thickness direction of the resin layer, the first electrically-conductive layer has a first shape, the first shape being a first wavy shape including a plurality of protrusions that are convexed toward the resin layer, wherein an amplitude of the first wavy shape along the thickness direction is smaller than a thickness of the resin layer.

### Advantageous Effects of Invention

According to embodiments of the present disclosure, electrodes for power storage devices that allow the rate characteristics of power storage devices to be improved are provided.

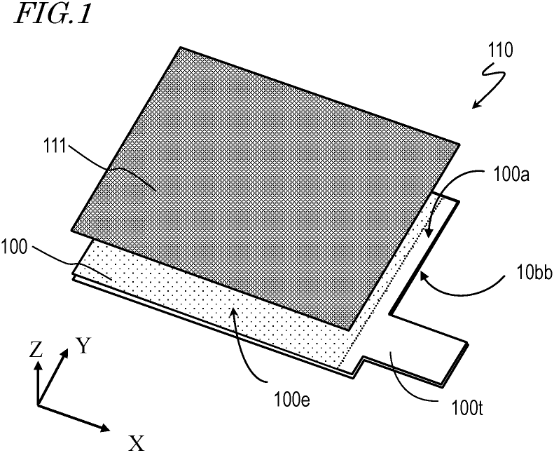

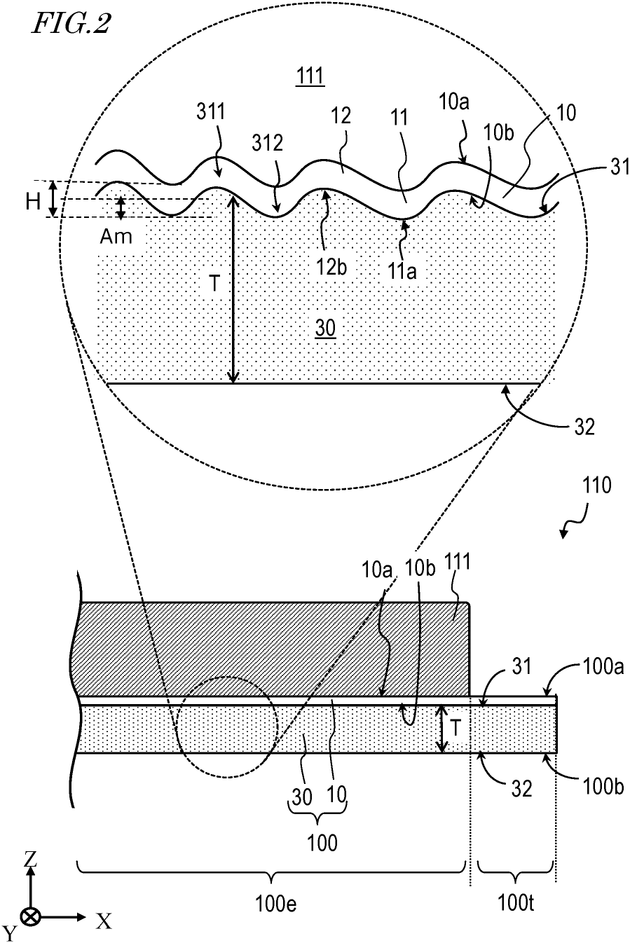

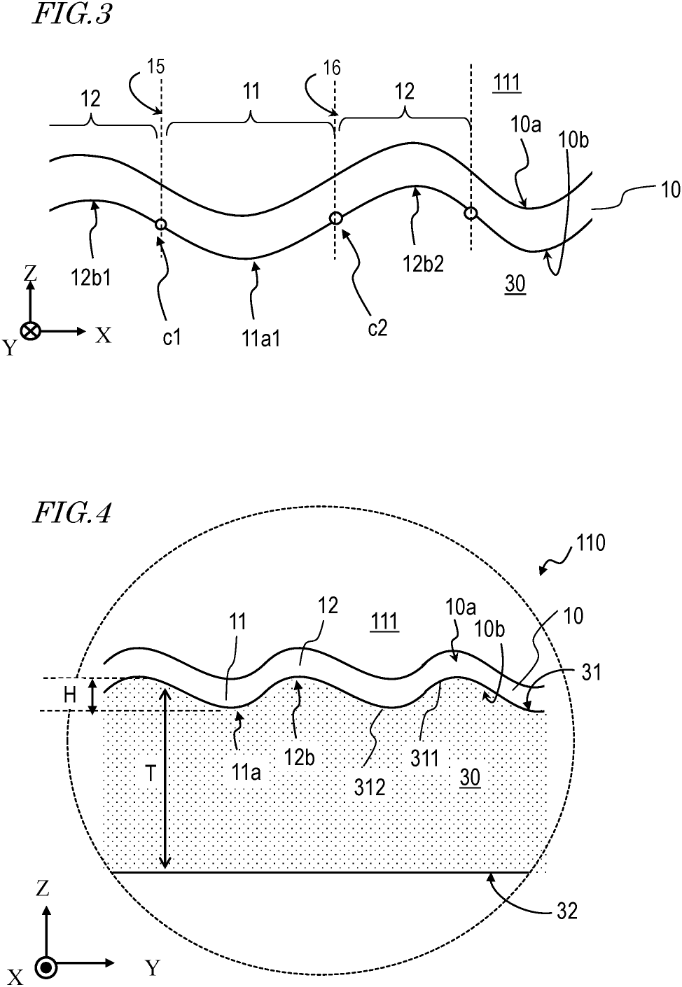

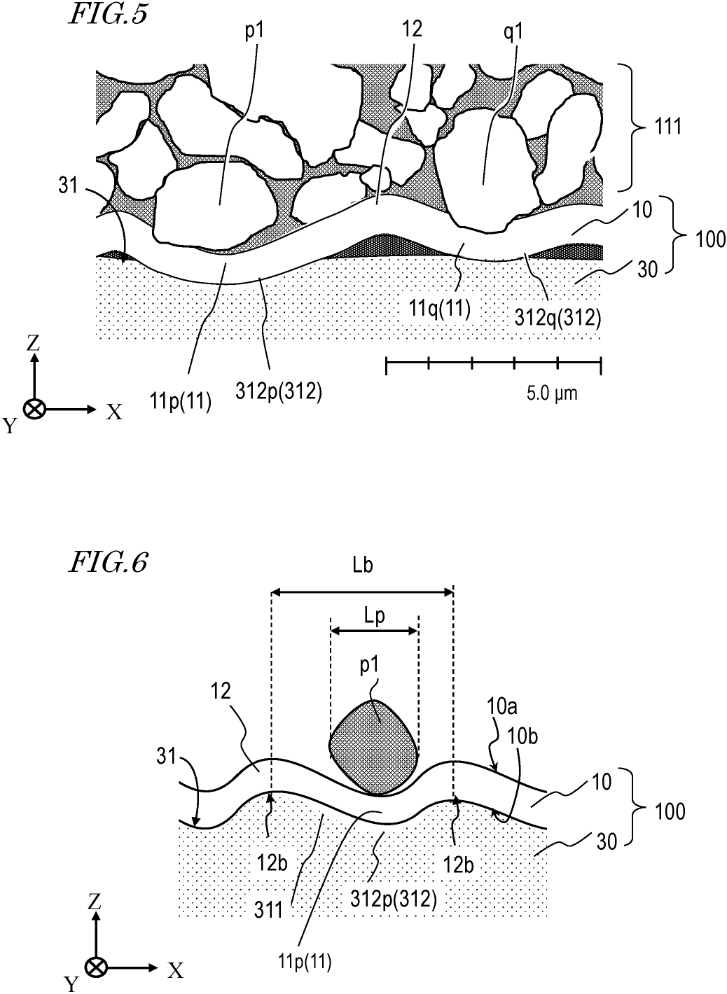

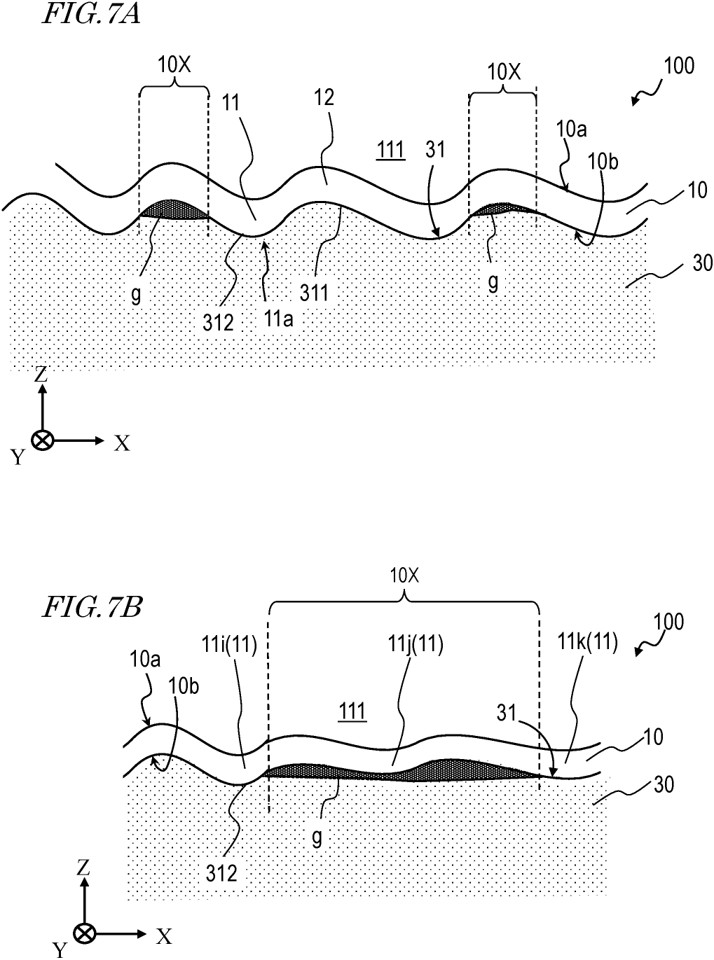

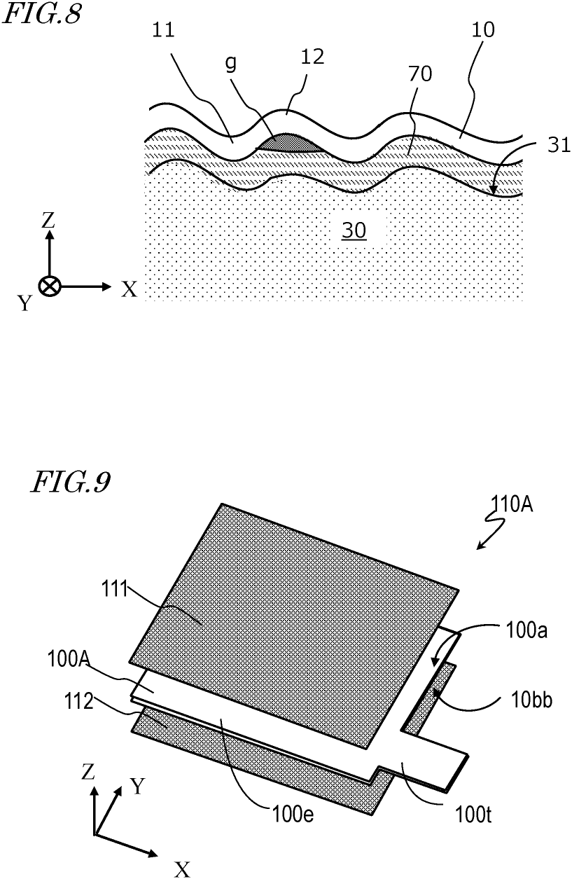

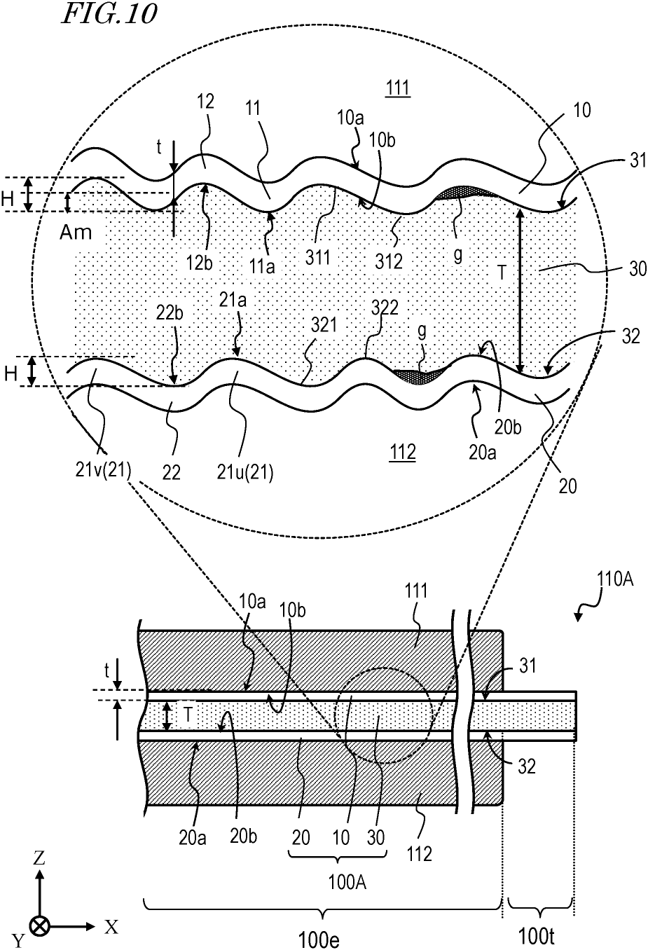

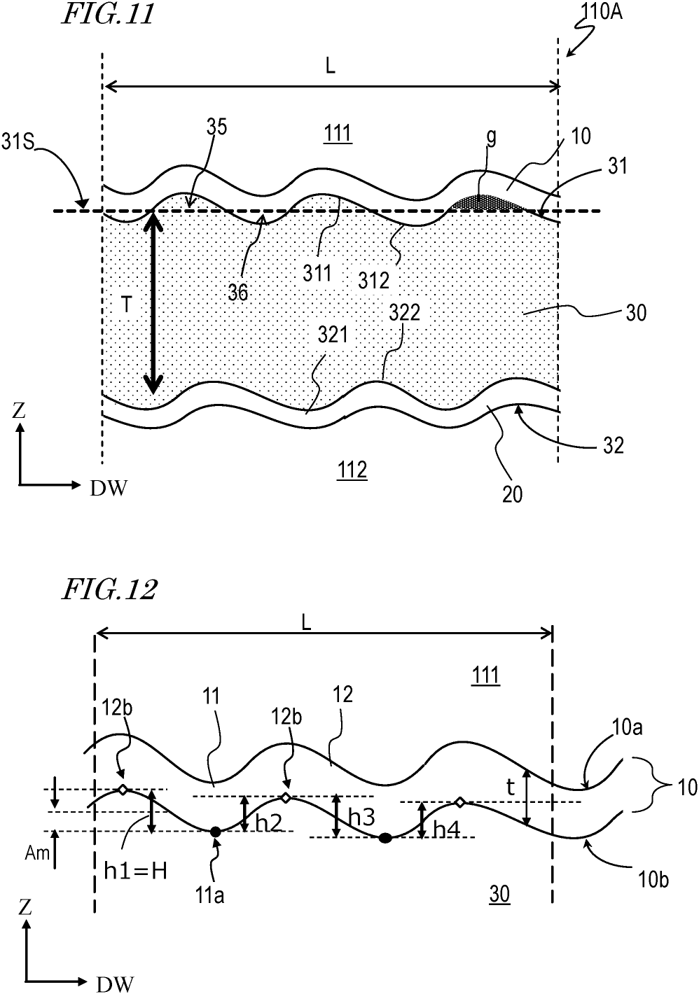

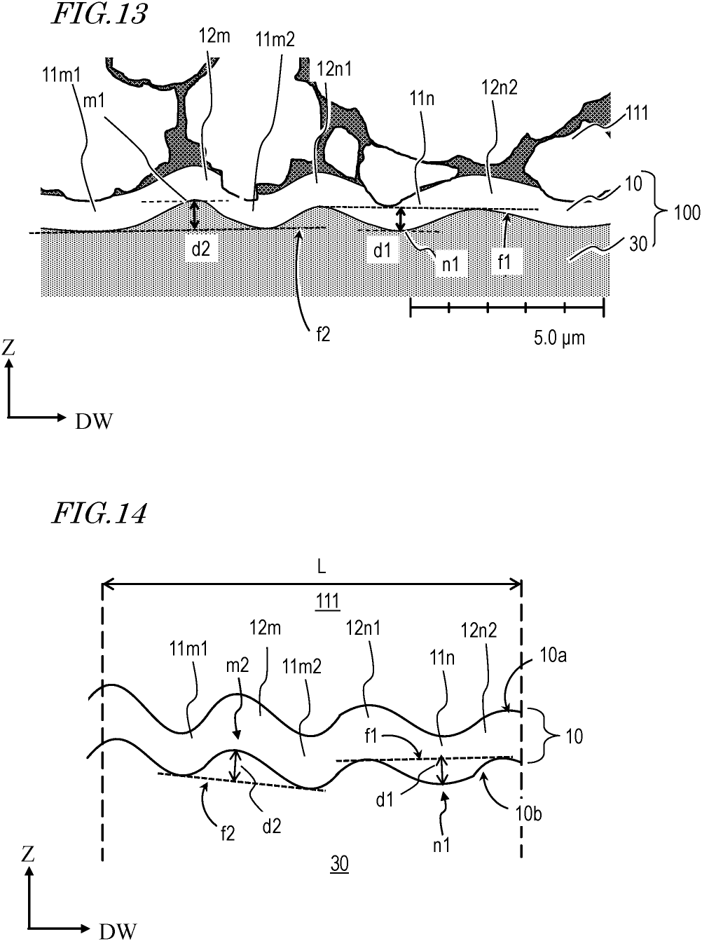

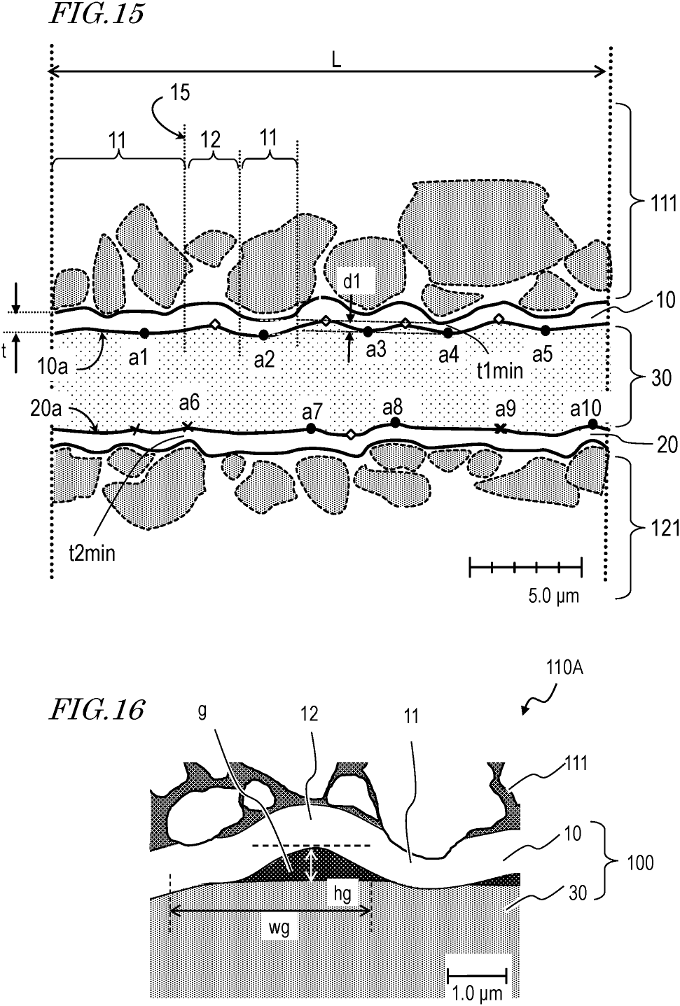

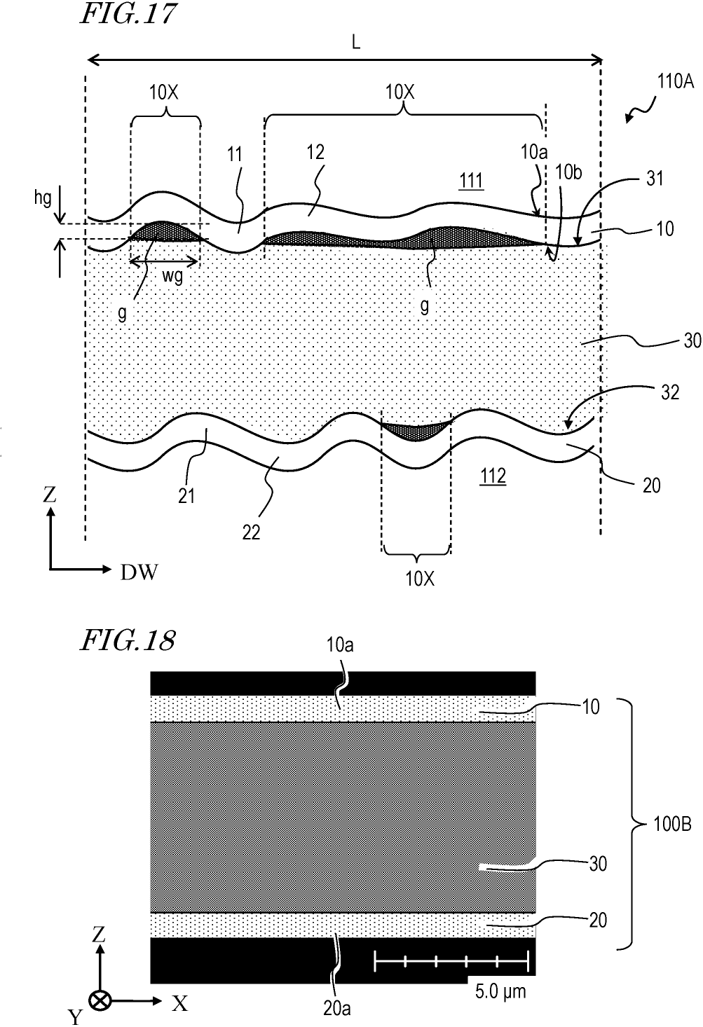

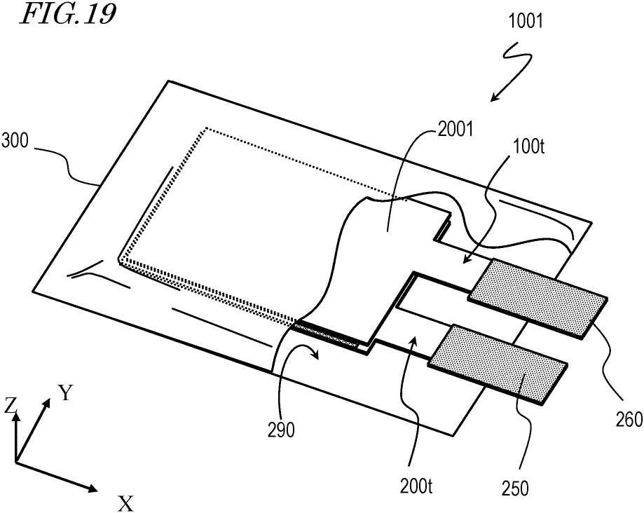

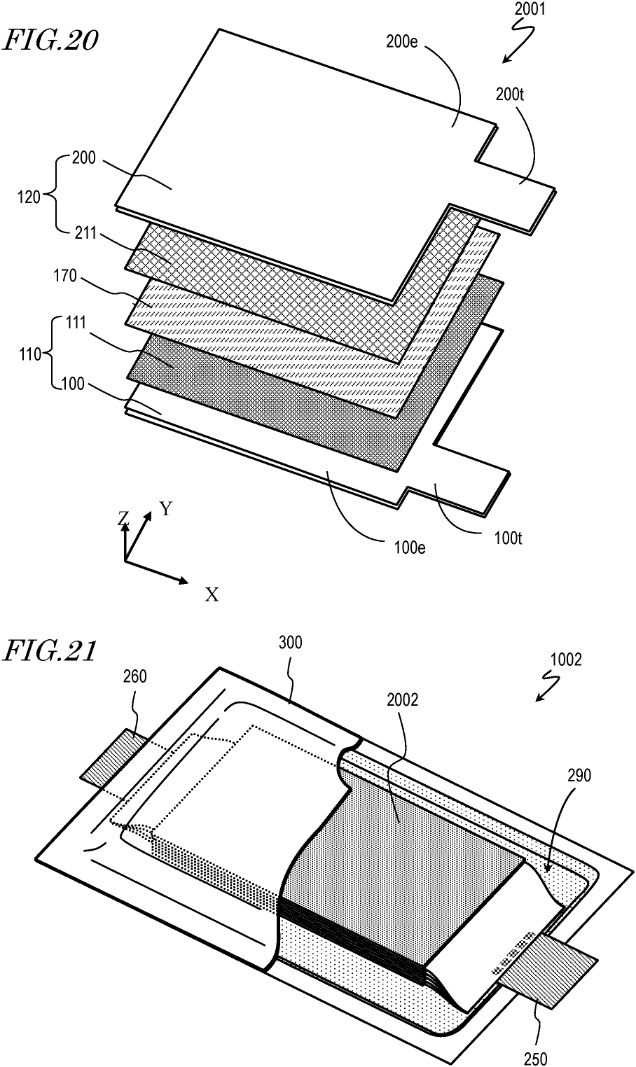

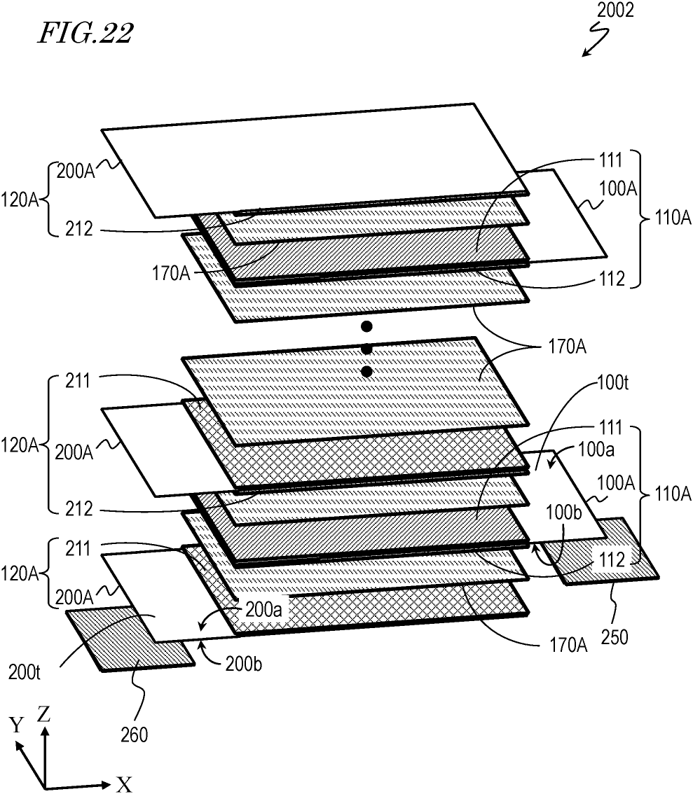

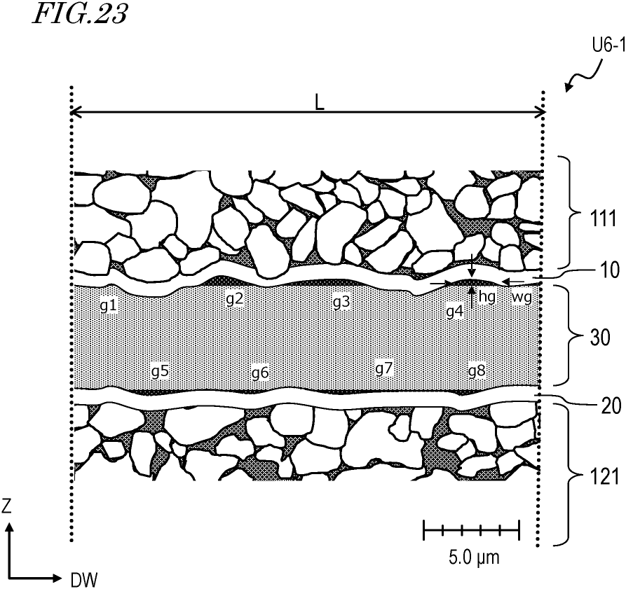

### BRIEF DESCRIPTION OF DRAWINGS

[FIG. 1] An exploded perspective view of a first electrode according to an embodiment of the present disclosure.

[FIG. 2] A schematic cross-sectional view showing a portion of a cross section parallel to the XZ plane of the first electrode shown in FIG. 1.

[FIG. 3] A schematic cross-sectional view showing a portion of the first electrode for describing the shape of a first electrically-conductive layer.

[FIG. 4] A schematic cross-sectional view showing a portion of a cross section parallel to the YZ plane of the first electrode shown in FIG. 1.

[FIG. 5] A diagram showing a partial cross section of the first electrode, presenting a schematic representation based on a cross-sectional SEM image.

[FIG. 6] A schematic cross-sectional view showing a portion of the first electrode for describing a relationship between a particle of a layer of particles and the first electrically-conductive layer.

[FIG. 7A] A schematic cross-sectional view showing a portion of another example of the first electrode.

[FIG. 7B] A schematic cross-sectional view showing a portion of another example of the first electrode.

[FIG. 8] A schematic cross-sectional view showing a portion of still another example of the first electrode.

[FIG. 9] An exploded perspective view showing a first electrode according to another embodiment of the present disclosure.

[FIG. 10] A schematic cross-sectional view showing a portion of the first electrode shown in FIG. 1.

[FIG. 11] A schematic cross-sectional view showing a unit cross section of the first electrode for describing a method of identifying the Z direction.

[FIG. 12] A schematic cross-sectional view showing a portion of a unit cross section of a first battery for describing a distance H.

[FIG. 13] A diagram showing a portion of a unit cross section of the first electrode, presenting a schematic representation based on a cross-sectional SEM image.

[FIG. 14] A schematic cross-sectional view showing a portion of a unit cross section of the first electrode for describing a protrusion height d1 and a recess depth d2.

[FIG. 15] A schematic representation based on a cross-sectional SEM image, showing a unit cross section U2-1 of Battery 2 according to Example 2.

[FIG. 16] A diagram showing a portion of a unit cross section of the first electrode, presenting a schematic representation based on a cross-sectional SEM image.

[FIG. 17] A schematic cross-sectional view showing a unit cross section of the first electrode for describing parameters of gaps g.

[FIG. 18] A diagram showing a partial cross section of a multilayer film before layers of particles are formed, presenting a schematic representation based on a cross-sectional SEM image.

[FIG. 19] A partial cutaway diagram showing an example of a power storage device.

[FIG. 20] An exploded perspective view depicting a cell taken out of the power storage device shown in FIG. 19.

[FIG. 21] A partial cutaway diagram showing another example of the power storage device.

[FIG. 22] An exploded perspective view depicting a cell and leads out of the power storage device shown in FIG. 21.

[FIG. 23] A schematic representation based on a cross-sectional SEM image, showing a unit cross section U6-1 of Battery 6 according to Example.

### DESCRIPTION OF EMBODIMENTS

Hereinafter, with reference to the drawings, embodiments of the present disclosure will be described. Numerical values, shapes, materials, steps, and orders of steps, etc., that are indicated in the following description are only exemplary, and admit of various modifications so long as it makes technological sense. The embodiments described below are also only exemplary, and can be combined in a variety of manners so long as it makes technological sense to do so.

The dimensions, shapes, etc. of any element shown in a drawing of the present disclosure may be exaggerated for ease of illustration. In the drawings of the present disclosure, in order to avoid excessive complexity, certain elements may be singled out for illustration, or certain elements may be omitted from illustration. Therefore, the dimensions of each element and the relative positioning between elements as depicted in the drawings of the present disclosure may not strictly reflect the dimensions of each element and the relative positioning between elements in an actual device. In the present disclosure, the notions “perpendicular” and “orthogonal” encompass any two straight lines, sides, faces, etc., making an angle within about ±5° of 90°, without being limited to making an angle of exactly 90°. In the present disclosure, the notion “parallel” encompasses any two straight lines, sides, faces, etc., making an angle within about ±5° of 0°.

In the present specification, the term “cell” refers to a structure in which at least a pair of a positive electrode and a negative electrode are assembled into an integral unit. In the present specification, the term “battery” is used as a term encompassing various forms (e.g., battery modules and battery packs) that include one or more “cells” which are electrically connected to one another.

### Embodiments

An embodiment of an electrode for power storage devices according to the present disclosure (hereinafter abbreviated as an “electrode”) includes: a resin layer having a first surface and a second surface; a first electrically-conductive layer disposed on the first surface of the resin layer; and a first layer of particles. A “layer of particles” is a layer containing multiple particles, where the layer may contain any material other than the particles. The shape and size of a particle are not particularly limited so long as the first layer of particles can be stabilized to the resin layer. The first layer of particles is disposed on the opposite side of the first electrically-conductive layer from the resin layer. The first layer of particles may be a layer of active material particles containing a plurality of active material particles, for example.

In an electrode according to the present embodiment, the multilayer film including the first electrically-conductive layer and the resin layer may function as a current collector. In the present specification, such a multilayer film may be referred to as a “composite film”. The composite film may further include an electrically-conductive layer disposed on the second surface of the resin layer. In other words, the composite film may have a multilayer structure where an electrically-conductive layer is provided on each of the opposite surfaces of the resin layer. In this case, the electrically-conductive layer formed on the second surface of the resin layer is referred to as a “second electrically-conductive layer”. Similarly to the first electrically-conductive layer, the second electrically-conductive layer may also have a shape including a plurality of protrusions that are convexed toward the resin layer in a cross section parallel to the thickness direction of the layer of particles. Such a cross-sectional shape is referred to as a “second shape”. In the present specification, the first electrically-conductive layer and the second electrically-conductive layer may be collectively referred to as “electrically-conductive layers”.

An electrode according to the present embodiment may be used for a positive electrode or a negative electrode, or both, of a power storage device such as a lithium-ion secondary battery. The power storage device may include a single-layered cell(s) that is based on a pair of a positive electrode and a negative electrode, or a multi-layered cell(s) that includes multiple pairs of positive electrodes and negative electrodes. In any such power storage device or cell, one of the positive electrode and the negative electrode may be referred to as the “first electrode”, and the other may be referred to as the “second electrode”. The positive electrode and the negative electrode may be collectively referred to as “electrodes”.

Hereinafter, with reference to the drawings, an electrode according to the present embodiment and a power storage device incorporating the present embodiment will be described more specifically.

### [Electrode Structure]

FIG. 1 and FIG. 2 are schematic representations showing an example of an electrode for power storage devices (hereinafter abbreviated as an “electrode”) according to the present embodiment. FIG. 1 is a schematic exploded view of the electrode. FIG. 2 is a schematic cross-sectional view of the electrode shown in FIG. 1, which also shows an enlarged cross-sectional view of a region encircled by a dotted line in the figure. For simplicity, an electrode is illustrated which is for use in a single-layered cell that only includes a single pair of a positive electrode and a negative electrode. In the present specification, for ease of illustration, arrows indicating the X direction, the Y direction, and the Z direction, as three directions being orthogonal to one another, are shown in the figures. FIG. 2 shows a cross section parallel to the Z direction (a cross section perpendicular to the XY plane).

As shown in FIG. 1, the first electrode 110 includes a composite film 100 and a first material layer 111 supported on the composite film 100. The composite film 100 has an upper face 100a and a lower face 100b. The first material layer 111 is disposed on the upper face 100a of the composite film 100. In the illustrated example, the first material layer 111 is disposed only on a partial region of the composite film 100. The composite film 100 includes: a region 110e that overlaps the first material layer 111 as viewed in the Z direction; and a tab region 100t that is located outside of the first material layer 111 as viewed in the Z direction (i.e., not overlapping the first material layer 111). The tab region 100t may be used for connection with a lead, for example.

As shown in FIG. 2, the composite film 100 includes a resin layer 30 and a first electrically-conductive layer 10 supported on the resin layer 30. In the example shown in FIG. 2, the resin layer 30, the first electrically-conductive layer 10, and the first material layer 111 are stacked along the Z direction. The Z direction may be referred to as “the thickness direction of the resin layer 30”.

The resin layer 30 has a first surface 31 and a second surface 32 that is located on an opposite side from the first surface 31. The resin layer 30 has a thickness T. As will be described later, the thickness T is an average distance between the first surface 31 and the second surface 32 along the Z direction, for example.

The first electrically-conductive layer 10 is disposed on the first surface 31 side of the resin layer 30. The first electrically-conductive layer 10 has an outer surface 10a that is located on an opposite side from the resin layer 30 and an inner surface 10b that is located on the resin layer 30 side.

The first material layer 111 is disposed on an opposite side of the first electrically-conductive layer 10 from the resin layer 30. In other words, the first material layer 111 is disposed on the outer surface 10a side of the first electrically-conductive layer 10. The first material layer 111 is a layer of particles containing multiple particles. As described above, the “layer of particles” may be any layer containing multiple particles, and may also contain any substance (e.g., a binder) other than particles. The material of the multiple particles is not particularly limited. The multiple particles may contain active material particles, electrically-conductive particles, or both, for example.

In the illustrated example, the upper face 100a of the composite film 100 may be the outer surface 10a of the first electrically-conductive layer 10, for example. The lower face 100b of the composite film 100 may be the second surface 32 of the resin layer 30, for example. As will be described later, the composite film 100 may further include a second electrically-conductive layer that is disposed on the second surface 32 of the resin layer 30 side. In that case, the lower face 100b of the composite film 100 may be the outer surface of the second electrically-conductive layer. The present specification may employ terms including “upper” or “lower”, e.g., “upper face”, “lower face”, “upper layer”, and “lower layer”. However, these are for the mere convenience of describing the relative positioning between elements, rather than being intended to limit the attitude of the power storage device in use. For example, the “upper face” may refer to a surface that is located on the positive side of the Z direction in the figure, whereas the “lower face” may refer to a surface that is located on the negative side of the Z direction in the figure.

Next, with reference to an enlarged view shown in FIG. 2, the electrode structure according to the present embodiment will be described in more detail. In the present specification, the shapes of the first electrically-conductive layer and the resin layer will mainly be described with reference to a cross section parallel to the Z direction. In the following description, “in a cross section parallel to the Z direction” may simply be expressed as “in a cross-sectional view”.

### <First Shape of First Electrically-Conductive Layer>

As shown enlarged in FIG. 2, in a cross section parallel to the Z direction, the first electrically-conductive layer 10 of the first electrode 110 has a first shape that includes a plurality of protrusions (which may be referred to as “first protrusions”) 11. The first shape may further include a recess 12 (which may be referred to as a “first recess”) being located between two adjacent protrusions 11. In the example shown in FIG. 2, the first shape includes a plurality of protrusions 11 and a plurality of recesses 12.

In a cross-sectional view, each protrusion 11 is a curved portion that is convexed toward the resin layer 30. In other words, opposite surfaces (the outer surface 10a and the inner surface 10b) of the first electrically-conductive layer 10 are rounded in a convex shape toward the resin layer 30 side at each protrusion 11. In the illustrated example, the “resin layer side” is the negative side of the Z direction (i.e., -Z side). At each protrusion 11, the outer surface 10a and the inner surface 10b of the first electrically-conductive layer 10 are convexed in the same direction (toward the resin layer 30 side), without having to be parallel to each other. In a cross section parallel to the Z direction, so long as each protrusion 11 is convexed toward the resin layer 30 side as a whole, the upper face and/or the lower face (which in this example are the portions of the outer surface 10a and the inner surface 10b of the first electrically-conductive layer 10 that are located at the protrusions 11) of the protrusion 11 may include a stepped portion, a flat surface that can be expressed by a straight line, and the like.

In the present specification, in a cross-sectional view, a given layer (or a given surface) being “curved” means that a cross-sectional shape of the layer (or the surface) is rounded as a whole. Therefore, “a shape that is curved” in a cross-sectional view may encompass not only a shape that is composed of one or more arced portions lacking any corners, but also a shape that is composed of an arced portion(s) and a linear portion(s). Note that being “arced” means being curve-shaped in a cross-sectional view, without being limited to an arched shape, or a circular arc.

Each protrusion 11 has a top point 11a. The “top point of a protrusion” may be, in a cross section parallel to the Z direction, a point on the inner surface 10b of the first electrically-conductive layer 10 that is located farthest in the -Z direction of that protrusion 11 (i.e., toward the second surface 32 of the resin layer 30), for example. In the cross section illustrated in FIG. 2, the top point 11a is a point that defines a minimal point of the surface of the protrusion 11 at the resin layer side. In other words, each top point 11a is, in a cross-sectional view, a point that corresponds to a minimal point when regarding the shape of the inner surface 10b as a curve. The protrusion 11 may have a substantially-flat top surface at its top. When the top surface of the protrusion 11 is parallel to the XY plane, the top point 11a may be any arbitrary point on the top surface.

Each recess 12 may be any portion that is located between two adjacent protrusions 11, and the cross-sectional shape of the recess 12 is not particularly limited. In a cross-sectional view, each recess 12 may include a curved portion that is concaved away from the resin layer 30, or may include a flat portion that is not curved. Alternatively, it may include a concaved curved portion and a flat portion. In a cross-sectional view, the “flat portion” may include a portion in which the outer surface 10a and the inner surface 10b of the first electrically-conductive layer 10 are expressed by straight lines which are parallel to each other, for example. In the cross section illustrated in FIG. 2, each recess 12 is concaved away from the resin layer 30. In other words, in the recess 12, the outer surface 10a and the inner surface 10b of the first electrically-conductive layer 10 are concaved away from the resin layer 30. In the recess 12, the outer surface 10a and the inner surface 10b of the first electrically-conductive layer 10 are curved in the same direction, without having to be parallel to each other.

Each recess 12 has a bottom point 12b. The “bottom point of a recess” may be, in a cross section parallel to the Z direction, a point on the inner surface 10b of the first electrically-conductive layer 10 that is located farthest in the +Z direction of that recess 12, for example. In the illustrated cross section, the bottom point 12b is a point that defines a maximal point of the surface of the recess 12 at the resin layer side. In other words, each bottom point 12b is, in a cross-sectional view, a point that corresponds to a maximal point when regarding the shape of the inner surface 10b as a curve. Note that the surface of each recess 12 on the resin layer side may have a bottom surface that is parallel to the XY plane. In this case, the bottom point may be any arbitrary point on the bottom surface.

The boundary between a protrusion 11 and a recess 12 can be defined as follows, for example. FIG. 3 is a partially enlarged view for describing the shape of the first electrically-conductive layer. In a cross section parallel to the Z direction, a curve representing the inner surface 10b of the first electrically-conductive layer 10 may have a top point (which herein is a minimal point) 11a1 of a protrusion 11, a bottom point (which herein is a maximal point) 12b1 of a recess 12 that is located on the -X side of the protrusion 11, a bottom point 12b2 of a recess 12 that is located on the +X side of the protrusion 11, an inflection point c1 that is located between the top point 11a1 and the bottom point 12b1, and an inflection point c2 that is located between the top point 11a1 and the bottom point 12b2, for example. An “inflection point” refers to a point where the curve changes from protruding downward to protruding upward, or a point where the curve changes from protruding downward to protruding upward. A line 15 parallel to the Z direction that passes through the inflection point c1 and a line 16 parallel to the Z direction that passes through the inflection point c2 may be the respective boundary lines between the protrusion 11 and the recesses 12 located on opposite sides thereof. The width of the protrusion 11 along the X direction may be the distance between the line 15 and the line 16, for example. In the case where a line representing the inner surface 10b of the first electrically-conductive layer 10 includes a stepped portion or a linear portion in a cross section parallel to the Z direction, an approximate curve representing the inner surface 10b may be determined through e.g. image analysis, and inflection points may be determined from that curve.

In the present embodiment, as shown in FIG. 2, in a cross section parallel to the Z direction, a distance H from one of the top points 11a of two adjacent protrusions 11 of the first electrically-conductive layer 10 to the bottom point 12b of the recess 12 along the Z direction is smaller than the thickness T of the resin layer 30. For example, in a cross section being parallel to the Z direction and having a predetermined width (width perpendicular to the Z direction), the distance H associated with each of the plurality of protrusions 11 may be smaller than the thickness T. The predetermined width may be a reference length L (e.g. 25 µm) to be described below, for example.

As shown in FIG. 2, the first shape of the first electrically-conductive layer 10 may be a wavy shape. A “wavy shape” may be inclusive of a “billowing” shape that contains repetitions of multiple protrusions 11 and multiple recesses 12, for example. In a wavy shape, protrusions 11 convexed toward the resin layer 30 and recesses 12 including a portion(s) concaved away from the resin layer 30 may be alternately disposed. The wavy shape encompasses waves which randomly change in height, amplitude, or wavelength. It suffices if the first electrically-conductive layer 10 has a wavy shape as a whole; for example, flat portions may be included between protrusions. In the illustrated example, the wavy shape of the first electrically-conductive layer 10 (which may also be referred to as the “first wavy shape”) has an amplitude Am which is smaller than the thickness T of the resin layer 30. The amplitude Am may be determined from the profile of the inner surface 10b of the first electrically-conductive layer 10 in a cross section parallel to the Z direction, by using image analysis software, for example. Observation, analysis, measurement, etc., of amplitude may be performed by other methods. Observation may be performed by producing observation samples. For example, the electrode may be embedded in resin, and after abrasion to expose its cross section, the cross section may be precision-finished by ion milling, thereby producing an observation sample. Next, for example, the observation sample may be subjected to observation and analysis, by using Keyence microscope or the like, in order to determine the amplitude Am. Alternatively, for example, what is ½ of the distance along the Z direction between a point located farthest in the -Z direction and the point located farthest in the +Z direction of the wavy shape may be determined from a photograph of a cross section being parallel to the Z direction and having a predetermined width (reference length L), and this may be defined as the amplitude of the wavy shape.

In the present specification, the “first shape” and the “wavy shape” are inclusive of shapes lacking regularity in terms of the arrangement of the recesses 12 and the protrusions 11. For example, the distance between the top points 11a of two adjacent protrusions 11 along the X direction (corresponding to the wavelength of the waveform) may not be constant. As illustrated, the array pitch of the protrusions 11 may be random. The array pitch of the protrusion 11 may be the distance between the top points 11a of protrusions 11 along the X direction, for example. Moreover, the size of the protrusions 11 and the size of the recesses 12 may not be uniform. The array pitch of the protrusion 11, the sizes of the protrusions 11 and the recesses 12, etc., in the first shape can be determined from a microscopic image representing a cross section parallel to the Z direction, as will be described later.

The enlarged view shown in FIG. 2 depicts a cross section parallel to the X direction (XZ cross section) of the first electrode 110. Among other cross sections perpendicular to the XY plane, the first electrically-conductive layer 10 in the present embodiment may also have the first shape including a plurality of protrusions 11, in a cross section parallel to any other direction (e.g., the Y direction) that intersects the X direction.

FIG. 4 is a schematic representation showing enlarged a portion of a YZ cross section of the first electrode 110 shown in FIG. 1. As shown in FIG. 4, in a cross section parallel to the Y direction orthogonal to the X direction, too, the first electrically-conductive layer 10 has the first shape including a plurality of protrusions 11. Although cross sections in any direction other than the X direction and the Y direction are not shown, the first electrically-conductive layer 10 may have the first shape in cross sections in three or more different directions on the XY plane. As a result, within the plane of the first electrically-conductive layer 10, stress concentration can be suppressed, and stress can be relaxed in a more uniform manner. The plurality of protrusions 11 may be randomly disposed in the XY plane.

Note that the positioning of the protrusions 11 and recesses 12 in the first shape is not limited to the above. The plurality of protrusions 11 and the plurality of recesses 12 may be regularly arranged. Being “regularly arranged” encompasses being disposed in such a manner that the array pitch of the protrusions, the size of the protrusion and/or the recess, etc., periodically change.

In the first electrode 110 shown in FIG. 2, the first electrically-conductive layer 10 supported on the resin layer 30 has the aforementioned first shape, and the thickness T of the resin layer 30 is larger than the distance H of the first shape. Alternatively, the first shape of the first electrically-conductive layer 10 is a wavy shape, having a smaller amplitude Am than the thickness T of the resin layer 30. As a result, the stress acting on the first electrically-conductive layer 10 from the first material layer 111 (which is a layer of particles) can be relaxed through deformation of the first electrically-conductive layer 10 and the resin layer 30. This can suppress deterioration, e.g., lowering of electrical conductivity of the first electrode 110. As used herein, the “stress acting on the first electrically-conductive layer from the first material layer” may include: stress acting on the first electrically-conductive layer 10 during a step of forming a layer of particles on the first electrically-conductive layer 10 (e.g., a calendering step; stress acting on the first electrically-conductive layer 10 during operation of the power storage device owing to expansion/shrinkage of the layer of particles; and so on. As will be described later, the first electrode 110 may include a gap(s) between the first electrically-conductive layer 10 having the first shape and the resin layer 30. As a result, internal stress occurring in the first electrically-conductive layer 10 during formation of the first electrically-conductive layer 10 can be reduced, whereby lowering of electrical conductivity due to internal stress can be suppressed.

### • Region in Which First Shape Is Formed

With reference to FIG. 2, an example of a range in which the first shape is formed will be described. The first electrically-conductive layer 10 may at least partially possess the first shape. The portion of the first electrically-conductive layer 10 that possesses the first shape is referred to as the “first region”. Along the Z direction, the first region at least partially overlaps the first material layer 111. Along the Z direction, the entire first region may overlap the first material layer 111. In other words, within the first electrode 110, the first shape may be formed across an entire region 100e that overlaps the first material layer 111 along the Z direction. Because the first electrically-conductive layer 10 has the first shape between the first material layer 111 and the resin layer 30, stress acting on the first electrically-conductive layer 10 owing to expansion/shrinkage of the first material layer 111 can be relaxed in a power storage device in which the first electrode 110 is used.

In one example, the portion of the first electrically-conductive layer 10 that is located in the region 100e may be the first region having the first shape, while the portion that is located in the tab region 100t may be a flat region. The flat region may be a region in which the inner surface 10b and the outer surface 10a of the first electrically-conductive layer 10 are parallel to the XY plane, for example. The flat region includes a region in which differences in height of the inner surface 10b of the first electrically-conductive layer 10 along the Z direction are within 5% of the thickness of the first electrically-conductive layer 10 in the tab region 100t.

### <Shape of First Surface of Resin Layer>

As shown in FIG. 2, in a cross section parallel to the Z direction, the first surface 31 of the resin layer 30 may include a plurality of concave regions (which may also be referred to as the “first concave regions”) 312. The first surface 31 may include a convex region (“which may also be referred to as the first convex region”) 311 between two adjacent concave regions 312 among the plurality of concave regions 312. In the present embodiment, the first surface 31 of the resin layer 30 includes a plurality of concave regions 312 and a plurality of convex regions 311.

In a cross-sectional view, each concave region 312 is a concaved region of the first surface 31, including a “dent” formed in the first surface 31, for example. In the example shown in FIG. 2, regarding the Z direction, each concave region 312 is disposed corresponding to one of the plurality of protrusions 11 of the first electrically-conductive layer 10. Being “disposed corresponding to” a protrusion 11 encompasses the case where, as viewed in the Z direction, each concave region 312 at least partially overlaps the corresponding protrusion 11. For example, the point of each concave region 312 that is located farthest in the -Z direction may overlap the corresponding protrusion 11 as viewed in the Z direction.

The convex regions 311 may be convexed regions, or substantially flat (e.g., parallel to the XY plane). Regarding the Z direction, each convex region 311 may be disposed corresponding to one of the plurality of recesses 12 of the first electrically-conductive layer 10. In other words, as viewed in the Z direction, each convex region 311 may at least partially overlap a corresponding recess 12. For example, the point of each convex region 311 that is located farthest in the +Z direction may overlap a corresponding recess 12 as viewed in the Z direction.

The arrangement of the concave regions 312 on the first surface 31 of the resin layer 30 may be random. Moreover, the sizes of the concave regions 312 and the convex regions 311 may not be uniform.

The first surface 31 of the resin layer 30 may be a wavy shape including a plurality of concave regions 312, for example. The convex regions 311 and the concave regions 312 may be alternately disposed on the first surface 31. Note that, similarly to the wavy shape for the first electrically-conductive layer 10, the “wavy shape” is inclusive of shapes lacking regularity in terms of the arrangement of the concave regions 312. Moreover, it suffices if the first surface 31 has a wavy shape as a whole; for example, flat portions may be included between concave regions 312.

In the illustrated example, the resin layer 30 and the first electrically-conductive layer 10 are directly in contact; however, gaps may be partially formed between the resin layer 30 and the first electrically-conductive layer 10. Moreover, as will be described later, any other solid layer may be present between the resin layer 30 and the first electrically-conductive layer 10.

### <Relationship Between Shapes of First Electrically-Conductive Layer and Resin Layer and Layer of Particles>

Next, an example relationship between one particle in the first material layer, which is a layer of particles, and the first shape of the first electrically-conductive layer and the shape of the first surface of the resin layer will be described.

FIG. 5 is a diagram showing a partial cross section of the first electrode 110, presenting a schematic representation of a cross-sectional SEM image obtained through observation with a scanning electron microscope (SEM). As shown in FIG. 5, in a cross section parallel to the Z direction, among the multiple particles contained in the first material layer (layer of particles) 111, a particle p1 that is located near the interface between the first material layer 111 and the composite film 100 may be disposed corresponding to one protrusion 11p of the first electrically-conductive layer 10. Moreover, the protrusion 11p may be disposed corresponding to one concave region 312p of the resin layer 30. Similarly, another particle q1 may be disposed corresponding to a protrusion 11q of the first electrically-conductive layer 10, and the protrusion 11q may be disposed corresponding to a concave region 312q of the resin layer 30. As described above, being “disposed corresponding to” encompasses the case of at least partially overlapping along the Z direction. As illustrated, the thickness of the first electrically-conductive layer 10 may become smaller at the portion overlapping the particle p1 along the Z direction than in portions located on opposite sides thereof. In other words, the thickness of the first electrically-conductive layer 10 may become smaller at the protrusion 11p than at the recess 12. Herein, “the thickness of the first electrically-conductive layer” refers to the distance between the outer surface 10a and the inner surface 10b of the first electrically-conductive layer 10 along the Z direction.

FIG. 6 is a schematic cross-sectional view for describing a relationship between one particle p1 of the first material layer 111 and the first electrically-conductive layer 10 and the first surface 31 of the resin layer 30. As shown in FIG. 6, in a cross section parallel to the Z direction, at least a portion of the particle p1 contained in the first material layer 111 is located between two recesses 12 that are located on opposite sides of the protrusion 11p of the first electrically-conductive layer 10. The particle p1 may be an active material particle, for example. The particle p1 may be directly in contact or may not be in contact with the upper face of the protrusion 11p. At least a portion of the protrusion 11p may be located inside one concave region 312p of the resin layer 30. Although the protrusion 11p is directly in contact with the upper face of the concave region 312p in this example, the protrusion 11p may not be in contact with the upper face of the concave region 312p.

From such a relationship, it can be said that the protrusion 11p of the first electrically-conductive layer 10 receives at least a portion of the particle p1 contained in the first material layer 111. It can also be said that the first electrically-conductive layer 10 is curved so as to accept (accommodate) at least a portion of the particle p1.

In the illustrated example, the concave region 312p of the resin layer 30 receives at least a portion of the protrusion 11p of the first electrically-conductive layer 10. In other words, inside the concave region 312p, at least a portion of the protrusion 11p is accepted (accommodated). Each of the concave regions 312 may receive at least a portion of a corresponding protrusion 11.

Because the particle p1 and the first electrically-conductive layer 10 and the resin layer 30 have the aforementioned relationship, in a battery in which the first electrode 110 is used, for example, forces associated with expansion/shrinkage of a particle (e.g., an active material particle) p1 contained in the first material layer 111 can be absorbed through local deformation of the protrusion 11 of the first electrically-conductive layer 10 and the concave region 312 of the resin layer 30. This restrains expansion/shrinkage of the particle p1 from greatly deforming the entire composite film 100, forming significantly thin portions in the first electrically-conductive layer 10, or causing cracks (fissures) or breaking, whereby an increase in the resistance of the first electrically-conductive layer 10 can be suppressed.

In order to obtain the above structure, for example, the distance Lb between the bottom points 12b of two recesses 12 located on opposite sides of the protrusion 11p along the X direction may be not less than one time and not more than three times the size (e.g., the maximum width along the X direction) of the particle p1. In one example, in a cross section observed with a SEM, when the maximum width Lp of the particle p1 of the first material layer 111 along the X direction is 2 to 3 µm, the distance Lb may be 4 to 9 µm.

It suffices if at least one protrusion 11 of the first electrically-conductive layer 10 receives a particle of the first material layer 111, and not all protrusions 11 need to be disposed corresponding to particles. Similarly, it suffices if at least one concave region 312 of the resin layer 30 is disposed corresponding to a protrusion 11 receiving a particle. Moreover, when another layer is present between the resin layer 30 and the first electrically-conductive layer 10, there may be cases where any concave regions corresponding to protrusions and particles are not formed in the first surface 31 of the resin layer 30.

### <Gaps Between First Electrically-Conductive Layer and Resin Layer>

FIG. 7A and FIG. 7B are schematic enlarged cross-sectional views each showing another example of the first electrode, depicting the neighborhood of the interface between the first electrically-conductive layer 10 and the resin layer 30.

As shown in FIG. 7A, in a cross section parallel to the Z direction, the first electrode 110 may include one or more gaps g between the inner surface 10b of the first electrically-conductive layer 10 and the first surface 31 of the resin layer 30. In a direction (which herein is the X direction) orthogonal to the Z direction, each gap g is located between two protrusions 11 among the plurality of protrusions 11. The gap g may include an air layer. Other substances, such as an electrolyte, may be contained inside the gap g.

In the present specification, a “gap” refers to, regarding a plurality of solid layers of the first electrode 110 that are stacked in the Z direction, a portion (e.g., a space) that is created as two upper and lower adjacent solid layers (referred to as the “first solid layer” and the “second solid layer”) become partially spaced apart from each other along the Z direction. The gap g may be an internal space surrounded by the first solid layer and the second solid layer. In the illustrated example, the first solid layer is the resin layer 30, and the second solid layer is the first electrically-conductive layer 10, such that gaps g are created where the resin layer 30 and the first electrically-conductive layer 10 become partially spaced apart. It suffices if the gaps g are disposed between the first electrically-conductive layer 10 and the first surface 31 of the resin layer 30 along the Z direction. As will be described later, when another solid layer is provided between the first electrically-conductive layer 10 and the resin layer 30, the gap(s) may be provided between the other solid layer and the resin layer 30 or the first electrically-conductive layer 10.

In the example shown in FIG. 7A, the two gaps g are disposed between two adjacent protrusions 11 of the first electrically-conductive layer 10. The gaps g may be air layers, for example. The gaps g are located between the inner surface 10b of the first electrically-conductive layer 10 and the first surface 31 of the resin layer 30, and are in contact with the inner surface 10b and the first surface 31. The gaps g may be surrounded by the inner surface 10b and the first surface 31. In other words, the first electrically-conductive layer 10 includes portions that are in contact with the first surface 31 of the resin layer 30 and first portions 10X that are spaced apart from the first surface 31. Herein, a “protrusion that is in contact with the first surface” is inclusive of the case where at least a portion of the protrusion 11 (e.g., a portion including the top point 11a of the protrusion 11) is in contact with the first surface 31. The first portions 10X are not in contact with the first surface 31. Each first portion 10X is disposed between two protrusions 11 that are in contact with the first surface 31 of the resin layer 30.

As shown in FIG. 7B, a gap g may extend across two or more protrusions 11 in a direction perpendicular to the Z direction. In the illustrated example, the first electrically-conductive layer 10 includes a protrusion 11i, a protrusion 11j, and a protrusion 11k, in this order in the +X direction. Between the protrusion 11i and the protrusion 11k, the gap g extends from the protrusion 11i, past the protrusion 11j, and toward the protrusion 11k in the +X direction. In this case, the entirety of the portion of the first electrically-conductive layer 10 that is in contact with the gap g creates a single first portion 10X. In other words, in the first electrically-conductive layer 10 of the illustrated example, the first portion 10X is located between two protrusions 11i and 11k that are in contact with the first surface 31 of the resin layer 30.

When the gap g is disposed between the first electrically-conductive layer 10 and the resin layer 30, internal stress in the first electrically-conductive layer 10 can be reduced. Moreover, stress acting on the first electrically-conductive layer 10 from the first material layer 111 can be relaxed more effectively.

The inner surface 10b of the first electrically-conductive layer 10 is preferably in contact with the gap g. This will allow the internal stress in the first electrically-conductive layer 10 to be reduced more effectively. The inner surface 10b being “in contact with the gap g” encompasses the case where a portion of the inner surface 10b is a portion of a plane defining the gap g. It is more preferable that the gap g includes an air layer and that the inner surface 10b of the first electrically-conductive layer 10 is in contact with the air layer. As a result, the internal stress in the first electrically-conductive layer 10 can be relaxed even more effectively.

FIG. 8 is a partial cross-sectional view showing still another example of the electrode. In the example shown in FIG. 8, another solid layer 70 is provided between the first electrically-conductive layer 10 and the resin layer 30. In such a configuration, the gap g may be disposed between the first electrically-conductive layer 10 and the solid layer 70, for example. Although not so illustrated, the gap g may be disposed between the solid layer 70 and the resin layer 30.

### <Variation of the Electrode>

The electrode according to the present embodiment may further include a second electrically-conductive layer on the second surface of the resin layer. On an opposite side of the second electrically-conductive layer from the resin layer, a second layer of particles may be provided. Such an electrode may be used for a multi-layered cell having multiple pairs of positive electrodes and negative electrodes, for example.

FIG. 9 is a schematic exploded view showing another example of the electrode according to the present embodiment. FIG. 10 is a schematic cross-sectional view of the electrode shown in FIG. 9, which also shows an enlarged cross-sectional view of a region encircled by a dotted line in the figure. FIG. 10 is a cross section parallel to the Z direction. In the following description, component elements similar to those in FIG. 2 are denoted by like reference numerals, and their description may conveniently be omitted.

As shown in FIG. 9, the first electrode 110A includes: a composite film 100A having an upper face 100a and a lower face 100b; a first material layer 111 disposed on the upper face 100a of the composite film 100A; and a second material layer 112 disposed on the lower face 100b of the composite film 100A. Similarly to the electrode 110 shown in FIG. 1, the first material layer 111 and the second material layer 112 may not be provided on a tab region 100t of the composite film 100A.

As shown in FIG. 10, the composite film 100A includes a resin layer 30, a first electrically-conductive layer 10, and a second electrically-conductive layer 20. In a cross-sectional view, the second material layer 112, the second electrically-conductive layer 20, the resin layer 30, the first electrically-conductive layer 10, and the first material layer 111 are stacked upon one another in the Z direction.

The first electrode 110A includes the first electrically-conductive layer 10 and the first material layer 111 on the first surface 31 side of the resin layer 30. The shape of the first surface 31 of the resin layer 30 and the first shape of the first electrically-conductive layer 10 may be similar to the shapes described above with reference to FIG. 2.

The first electrode 110A differs from the first electrode 110 shown in FIG. 2 in that it includes the second electrically-conductive layer 20 and the second material layer 112 on the second surface 32 side of the resin layer 30.

The second electrically-conductive layer 20 is disposed on the second surface 32 side of the resin layer 30. The second electrically-conductive layer 20 may contain the same electrically-conductive material as that of the first electrically-conductive layer 10. The second electrically-conductive layer 20 includes: an outer surface 20a that is located on an opposite side from the resin layer 30; and an inner surface 20b that is located on the resin layer 30 side.

The second material layer 112 is disposed on an opposite side of the second electrically-conductive layer 20 from the resin layer 30. In other words, the second material layer 112 is disposed on the outer surface 20a side of the second electrically-conductive layer 20. The second material layer 112 is a layer of particles containing multiple particles. The second material layer 112 may contain the same material as that of the first material layer 111.

As shown enlarged in FIG. 10, in a cross section parallel to the Z direction, the second electrically-conductive layer 20 may have a second shape including a plurality of protrusions 21 that are convexed toward the resin layer 30. The second shape may be a similar shape to that of the first shape of the first electrically-conductive layer 10. In other words, in a cross section parallel to the Z direction, the second electrically-conductive layer 20 may further include a plurality of recesses 22. Each recess 22 may be located between two adjacent protrusions 21 among the plurality of protrusions 21, for example. Each recess 22 may be concaved away from the resin layer 30, or substantially flat. In the second electrically-conductive layer 20, too, a distance H from one of the top points 21a of two adjacent protrusions 21 to the bottom point 22b of a recess 22 along the Z direction may be smaller than the thickness T of the resin layer 30. The second shape may be a wavy shape (which may also be referred to as the “second wavy shape”). The wavy shape has an amplitude Am which is smaller than the thickness T of the resin layer 30. Because the second electrically-conductive layer 20 has the second shape, stress acting on the second electrically-conductive layer 20 from the second material layer 112 can be relaxed.

Similarly to the first surface 31, the second surface 32 of the resin layer 30 may include a plurality of concave regions 322 which are disposed corresponding to the protrusions 21. Each concave region 322 is a region that is concaved toward the first surface 31 (which in the illustrated example is the positive side of the Z direction). The second surface 32 may further include a plurality of convex regions 321. Each convex region 321 may be located between two adjacent concave regions 322 among the plurality of concave regions 322, for example. Each convex region 321 may be a region that is convexed toward the first electrically-conductive layer 10, or substantially flat (e.g., substantially parallel to the XY plane) .

Regarding the Z direction, each concave region 322 is disposed corresponding to one of the plurality of protrusions 21 of the second electrically-conductive layer 20. For example, as viewed in the Z direction, each concave region 322 may at least partially overlap a corresponding protrusion 21. Alternatively, a point on each concave region 322 that is located closest to the first surface 31 (i.e., +Z side) may overlap a corresponding protrusion 21 as viewed in the Z direction, for example.

In a cross section parallel to the Z direction, the first electrode 110A may include one or more gaps g between the inner surface 20b of the second electrically-conductive layer 20 and the second surface 32 of the resin layer 30. Each gap g is located between two adjacent protrusions 21 among the plurality of protrusions 21. The relative positioning between the gap(s) g and the second electrically-conductive layer 20 and resin layer 30 may be similar to the relationship between the gap(s) g and the first electrically-conductive layer 10 and resin layer 30 as described above with reference to FIG. 7A and FIG. 7B. Because the first electrode 110A has the gap(s) g between the second electrically-conductive layer 20 and the resin layer 30, internal stress in the second electrically-conductive layer 20 can be relaxed, whereby lowering of electrical conductivity due to internal stress in the second electrically-conductive layer 20 can be suppressed.

Note that the cross-sectional shape of the second electrically-conductive layer 20 is not particularly limited. A cross section of the second electrically-conductive layer 20 may not have the second shape. For example, the outer surface 20a and the inner surface 20b of the second electrically-conductive layer 20 may be substantially flat planes. However, as illustrated, it is preferable that both of the first electrically-conductive layer 10 and the second electrically-conductive layer 20 have protrusions that are curved toward the resin layer 30. As a result of this, stress from the first material layer 111 and the second material layer 112 disposed on opposite sides of the composite film 100A can be relaxed. Because this can suppress deformation and deterioration of the composite film 100A, an increase in the electrical resistance of the first electrode 110A can be suppressed.

### Relationship Between the First Shape and the Second Shape

An example relationship between the first shape of the first electrically-conductive layer 10 and the second shape of the second electrically-conductive layer 20 will be described.

In the example shown in FIG. 10, in a plane perpendicular to the Z direction (e.g., in the XY plane), the positions of the plurality of protrusions 21 in the second shape do not correspond to the positions of the plurality of protrusions 11 in the first shape. For example, in a cross section parallel to the Z direction, the plurality of protrusions 21 in the second shape may include: a protrusion 21u at least partially overlapping one of the plurality of protrusions 11 in the first shape along the Z direction; and a protrusion 21v not overlapping any of the plurality of protrusions 11 along the Z direction. Thus, because the protrusions in the first shape and the second shape do not correspond to each other in position within the XY plane, it is possible to restrain locally-increased stress from acting on the resin layer 30.

Moreover, along a perpendicular direction to the Z direction (e.g., the X direction), the position(s) of the gap(s) g located between the first electrically-conductive layer 10 having the first shape and the resin layer 30 do not need to correspond to the position(s) of the gap(s) g located between the second electrically-conductive layer 20 having the second shape and the resin layer 30.

### <Parameters Concerning Cross-Sectional Shape Of Electrically-Conductive Layer and Surface Shape of Resin Layer>

An electrode according to the present embodiment has a structure in which a layer(s) of particles is formed on a composite film. Therefore, it is difficult to directly analyze the shapes of the electrically-conductive layers and the resin layer across the entire XY plane of the composite film. Therefore, the inventors have identified parameters which can be determined by observing a cross section parallel to the X direction of the electrode and which may affect the characteristics of the electrode, thus to examine their relationships with the electrode characteristics.

The method of observing a cross section of the electrode is not particularly limited. In the present embodiment, a cross section of the electrode that is parallel to the stacking direction (the Z direction) is observed with a scanning electron microscope (SEM: Scanning Electron Microscope) .

In the present specification, a cross section which is parallel to the Z direction, such that the length of its cross section along a perpendicular direction to the Z direction (hereinafter referred to as the “width direction”) DW equals a predetermined length L, is referred to as a “unit cross section”. The direction DW of the unit cross section may be parallel to the X direction or the Y direction, or be a direction that intersects the X direction and the Y direction. The length L may be 20 µm or more. In the present specification, it is assumed that the length L is 25 µm. Preferably, from a single electrode, a plurality of observation samples may be produced while varying its width direction DW, in order to observe a plurality of unit cross sections.

Furthermore, for each parameter, a specific example of a suitable numerical range in a unit cross section that is observable with a SEM or other microscopes may be described below. In this case, it suffices if the numerical value of the parameter as determined by observing at least one arbitrary unit cross section falls within the suitable range. Preferably, a mean value of the numerical values of the parameter in three or more unit cross sections falls within the suitable range. Preferably, these three or more unit cross sections are unit cross sections with mutually different width directions, and may include two unit cross sections having mutually orthogonal width directions DW, for example. More preferably, a mean value among five or more unit cross sections may fall within the suitable range.

Described below with reference to FIG. 11 to FIG. 17 are parameters for optimizing the electrode structure, e.g., the cross-sectional shape(s) of the electrically-conductive layer(s), the state (including gap positions and shape) of the interface between the electrically-conductive layer(s) and the resin layer, in an electrode according to the present embodiment. Suitable ranges for parameters concerning the first shape of the first electrically-conductive layer and the second shape of the second electrically-conductive layer may be identical, and suitable ranges for parameters concerning the first surface and the second surface of the resin layer may be identical. Therefore, in the following, a cross-sectional shape of an electrically-conductive layer may be described by taking the first shape of the first electrically-conductive layer of the first electrode as an example, and the surface shape of the resin layer may be described by taking the shape of the first surface of the resin layer as an example.

### (A) Z Direction

As shown in FIG. 2, when the second surface 32 of the resin layer 30 is substantially flat, in a cross-sectional microscopic image (e.g., a cross-sectional SEM image) of the electrode, the normal direction of the second surface 32 of the resin layer 30 defines the “Z direction”. On the other hand, as shown in FIG. 10, when the first surface 31 and the second surface 32 of the resin layer 30 both have surface concavities and convexities, it may be difficult to identify the “Z direction”. Therefore, an example method of identifying the Z direction through cross-sectional observation will be described.

FIG. 11 is a schematic cross-sectional view showing a portion of a unit cross section of the electrode 110A. As shown in FIG. 11, in a unit cross section, an imaginary reference plane 31S may be drawn of the surface of either one of the first surface 31 and the second surface 32 (which herein is the first surface 31), and the normal direction of the reference plane 31S may be defined as the “Z direction”. The reference plane 31S may be determined by using image analysis software such as “A-zou Kun” (TM) manufactured by Asahi Kasei Engineering Corporation, for example. For instance, an image of a unit cross section may be analyzed, and a mean plane that is calculated from the profile of the first surface 31 of the resin layer 30 may be defined as the reference plane 31S, and the normal direction of the mean plane may be defined as the Z direction.

Alternatively, the reference plane 31S may be a plane such that, in a unit cross section, a total area of regions 35 defined by the reference plane 31S and a plurality of portions of the first surface 31 that are located above the reference plane 31S is substantially equal to a total area of regions 36 defined by the reference plane 31S and a plurality of portions of the first surface 31 that are located below the reference plane 31S.

### (B) Thickness T of the Resin Layer 30

With reference to FIG. 11, the thickness T of the resin layer 30 will be described. The thickness T of the resin layer 30 can be determined by, for example, in a given unit cross section, as an arithmetic mean of distances between the second surface 32 and the first surface 31 of the resin layer 30 along the Z direction.

In the tab region (the tab region 100t shown in FIG. 2), when the first surface 31 and the second surface 32 of the resin layer 30 is substantially flat, the thickness of the resin layer 30 in the tab region may be measured, and the thickness T may be determined by approximation. However, there may be cases where the thickness of the resin layer 30 in the tab region is greater (e.g., about 1 to 1.1 times greater) than the thickness T of the resin layer 30 in a region overlapping the first material layer 111 (the region 100e shown in FIG. 2).

The thickness T of the resin layer 30 may be e.g. 3 µm or more. When the thickness T is 3 µm or more, stress acting on the electrically-conductive layer(s) can be absorbed more effectively. Moreover, mechanical strength for a current collector can be ensured. Preferably, the thickness T is 5 µm or more. On the other hand, from the standpoint of energy density improvement, the thickness T may be 12 µm or less, and preferably 6 µm or less.

### (C) Distance H

As one of the parameters concerning differences in height of the first shape of the first electrically-conductive layer along the Z direction, the distance H may be determined.

FIG. 12 is a schematic cross-sectional view showing a portion of a unit cross section of the first electrode 110. As shown in FIG. 12, in a given unit cross section, distances h1 to hn (where n is an integer equal to or greater than 2) along the Z direction between the top point 11a of each protrusion 11 and the bottom points 12b of two adjacent recesses 12 on opposite sides thereof may be determined, and a maximum value h(max) among such distances may be defined as the “distance H”. More preferably, for each of two or more unit cross sections, a maximum value h(max) among distances h1 to hn may be determined, and a mean value thereof is defined as the “distance H”. As described above, in the present embodiment, the distance H is smaller than the thickness T of the resin layer 30. As a result of this, stress acting on the first shape of the first electrically-conductive layer 10 can be relaxed by the resin layer 30 with a sufficient thickness, whereby lowering of electrical conductivity of the first electrically-conductive layer 10 can be suppressed. The distance H may be less than ½ of the thickness T of the resin layer 30.

On the other hand, the distance H may be ⅒ or more of the thickness t of the first electrically-conductive layer 10, for example. Alternatively, the distance H may be 0.2 µm or more. This provides an effect of more effectively relaxing stress. Although depending on the size of the particles in the layer of particles, this makes it easier for the particles to be received by the first shape, whereby local stress due to the particles can be relaxed. The “thickness t of the first electrically-conductive layer” may be a mean value, in each unit cross section, of distances between the outer surface and the inner surface of the first electrically-conductive layer 10 along the Z direction, for example. Alternatively, when the tab region (the tab region 100t shown in FIG. 2) of the composite film is a flat region, the thickness of the first electrically-conductive layer 10 in the tab region may be measured as the thickness t.

When the first electrically-conductive layer 10 has a wavy shape in a cross-sectional view, the amplitude Am of the wavy shape can also be determined from a unit cross section. The amplitude Am may be determined as ½ of the distance H, for example. As described above, the amplitude Am may be determined by using pixel analysis software.

In the present embodiment, the amplitude Am is smaller than the thickness T of the resin layer 30. As a result of this, stress acting on the first electrically-conductive layer 10 from the first material layer 111 can be effectively reduced. When the first electrically-conductive layer 10 and the second electrically-conductive layer 20 have wavy shapes in a cross-sectional view, the amplitude Am of the wavy shape of each electrically-conductive layer may be smaller than the thickness T.

As shown in FIG. 10, when each of the first electrically-conductive layer 10 and the second electrically-conductive layer 20 disposed on opposite surfaces of the resin layer 30 has a cross-sectional shape including a plurality of protrusions, the distances H associated with the first electrically-conductive layer 10 and the second electrically-conductive layer 20 are each preferably smaller than the thickness T, and more preferably less than ½ of the thickness T. As a result of this, concave regions formed on opposite surfaces of the resin layer 30 can be better prevented from becoming connected with each other. Therefore, lowering of electrical conductivity due to deformation of the electrode can be suppressed.

### (D) Protrusion Height D1, Recess Depth D2, Distance Dm1, Distance Dm2

As parameters concerning the sizes of concavities and convexities of the first shape, distance dm1 and/or distance dm2 as described below may be used, for example. The distance dm1 corresponds to an arithmetic mean of the heights (also referred to as “protrusion heights”) d1 of the protrusions included in each unit cross section, whereas the distance dm2 corresponds to an arithmetic mean of the depths (also referred to as “recess depths”) d2 of the recesses 12 included in each unit cross section.

FIG. 13 is a diagram showing a partial cross section of the first electrode, presenting a schematic representation based on a cross-sectional SEM image. FIG. 14 is a schematic representation showing a portion of a unit cross section of the first electrode.

The protrusion height d1 can be measured as follows, for example. As shown in FIG. 13 and FIG. 14, in a unit cross section and regarding the inner surface of the first electrically-conductive layer 10, firstly, a line (line segment) f1 connecting the bottom point of a recess 12n1 located on the -DW side of one protrusion 11n for measurement and the bottom point of a recess 12n2 located on the +DW side of the protrusion 11n is drawn. In this example, the line f1 is a tangent of the aforementioned two recesses. Next, in a perpendicular direction of the line f1, the distance between the line f1 and the protrusion 11n is measured. Regarding the protrusion 11n, a distance d1 between a point n1 that is the most distant from the line f1 along the perpendicular direction and the line f1 is defined as the “protrusion height”. The point n1 may be the top point of the protrusion 11n, for example.

Similarly, the recess depth d2 can be measured as follows. As shown in FIG. 13 and FIG. 14, in a unit cross section and regarding the inner surface of the first electrically-conductive layer 10, firstly, a line f2 connecting the top point of a protrusion 11m1 located on the -DW side of one recess 12m for measurement and the top point of a protrusion 11m2 located on the +DWX side of the recess 12m is drawn. In this example, the line f2 is a tangent of the aforementioned two protrusions. Next, in a perpendicular direction of the line f2, the distance between the line f2 and the recess 12m is measured. Regarding the recess 12m, a distance d2 between a point m1 that is the most distant from the line f2 along the perpendicular direction and the line f2 is defined as the “recess depth”. The point m1 may be the bottom point of the recess 12, for example.

In the present embodiment, for each of the protrusions 11 included in one or more unit cross sections, the protrusion height d1 is measured, and a mean value of them is defined as the distance dm1. For each of the recesses 12 included in one or more unit cross sections, the recess depth d2 is measured, and a mean value of them is defined as the distance dm2. When calculating the distance dm1 and the distance dm2, among the protrusion heights d1 and the recess depths d2 as measured by the above methods, for example, values that are less than 0.1 µm (or less than ⅒ of the thickness of the first electrically-conductive layer 10) are disregarded. As a result of this, minute concavities and convexities of the first electrically-conductive layer 10 are ignored, while allowing an arithmetic mean of those concavities and convexities which may greatly contribute to stress relaxation to be determined. In the present embodiment, as the parameter(s) concerning the sizes of the concavities and convexities, at least one of the distance m1 and distance m2 may be determined.

The distance dm1 may have a mean value of e.g. not less than 0.1 µm and not more than 3.0 µm. Similarly, the distance dm2 may be e.g. not less than 0.1 µm and not more than 3.0 µm. When the distance dm1 and/or the distance dm2 is/are 0.1 µm or more, stress acting on the first electrically-conductive layer 10 from the first material layer 111 can be relaxed more effectively. The distance dm1 and/or the distance dm2 is/are preferably 0.2 µm or more. On the other hand, when the distance dm1 and/or the distance dm2 is/are 3.0 µm or less, deformation of the electrode and increase in the resistance of the first electrically-conductive layer 10 due to significant local deformations of the first electrically-conductive layer 10 can be suppressed.

Furthermore, the heights d1 of the protrusions 11 included in one or more unit cross sections may have a maximum value of e.g. not less than 0.2 µm and not more than 3.0 µm. Similarly, the depths d2 of the recesses 12 included in one or more unit cross sections may have a maximum value of e.g. not less than 0.2 µm and not more than 3.0 µm. As a result of this, while suppressing deformations of the electrode, stress acting on the first electrically-conductive layer 10 from the first material layer 111 can be relaxed more effectively.

### (E) Identification of Protrusions and Recesses

When conducting comparisons and studies of the first shape, it is preferable to remove any minute concavities and convexities formed on the inner surface of the first electrically-conductive layer in a unit cross section. For example, the aforementioned measurement method of the protrusion height d1 can be utilized in removing the minute concavities and convexities. The method thereof will be described by using FIG. 15.

FIG. 15 is a line drawing showing a portion of a cross-sectional SEM image of an electrode as produced according to Examples described later, illustrating an exemplary unit cross section of the electrode along the width (length) L. First, as shown in FIG. 15, convex portions a1 to a10 of the first electrically-conductive layer 10, which are convexed toward the +Z side, are selected. Next, for the selected convex portions a1 to a10, the heights d1 of the convex portions are determined by the method illustrated in FIG. 13 and FIG. 14. Next, the relationship in size between the heights d1 of the convex portions a1 to a10 and a predetermined distance (e.g. 0.1 µm) is examined. Among the convex portions a1 to a10, only those convex portions whose height d1 is equal to or greater than the predetermined distance are regarded as the “protrusions 11”. Without being limited to 0.1 µm, the predetermined distance may be ⅒ of the thickness t of the first electrically-conductive layer 10, for example.

In the example shown in FIG. 15, among the convex portions a1 to a10, those convex portions a1 to a5, a7, a8 and a10 whose height d1 is 0.1 µm or more are regarded as the protrusions 11 of the first electrically-conductive layer 10. Since the convex portions a6 and a9 are minute convex portions whose height d1 is less than 0.1 µm, they do not count as protrusions. Similarly, as for the recesses 12, too, concave portions may be selected, and those concave portions whose distance d2 (i.e., depth) is equal to or greater than the aforementioned predetermined distance may be regarded as the recesses 12.

Furthermore, in the case where a boundary between a protrusion 11 and a recess 12 is needed, as has described above with reference to FIG. 3, an inflection point located between the top point of the protrusion 11 and the bottom point of the recess 12 may be determined on the inner surface 10b of the first electrically-conductive layer 10, and a line 15 which passes through the inflection point and which is parallel to the Z direction may be regarded as the boundary line. In FIG. 15, the top points 11a of the protrusions 11 are indicated with dark circles, whereas the bottom points 12b of the recesses 12 are indicated with blank rhombuses.

### (F) Number Na of Protrusions 11, Number Nb Of Recesses 12, Number of Concave Regions 312

With reference to FIG. 15, the numbers of protrusions 11, recesses 12, and concave regions 312 in a unit cross section will be described. Although the density of protrusions (or, an array pitch) in the first electrically-conductive layer may also be considered as one of the parameters, it is difficult to measure density from a cross section. Therefore, the number Na of protrusions in a unit cross section may be used as an alternative parameter to a density of protrusions 11 in the first shape. It is also possible to determine an array pitch of protrusions from the relationship between the number Na of protrusions in a unit cross section and the length (width) L of the unit cross section. Instead of the number Na of protrusions, the number Nb of recesses may also be used.

The number Na of protrusions 11 in a unit cross section may be e.g. not less than 2 and not more than 10. When it is 2 or more, for example, stress acting on the first electrically-conductive layer 10 from the first material layer 111 can be reduced more effectively. When it exceeds 10, the width of the protrusion 11 becomes smaller than a particle in the first material layer 111, thus making it difficult to receive particles. Although depending on the size of particles in the first material layer 111, if the number Na of protrusions 11 is e.g. not less than 2 and not more than 10, the interspace between adjacent recesses 12 will be a size that can easily accept a particle(s) in the first material layer 111, whereby deformation of the electrode due to expansion/shrinkage of the first material layer 111 can be suppressed. In a unit cross section shown in FIG. 15, the number Na of protrusions 11 of the first electrically-conductive layer 10 is 5, whereas the number Na of protrusions 21 in the second electrically-conductive layer 20 is 3. As used herein, the “number Na of protrusions” is the number of convex portions whose height d1 is 0.1 µm or more, where those convex portions which is significantly small relative to the thickness of the first electrically-conductive layer 10 are not counted.

Instead of the number Na of protrusions 11, the number Nb of recesses 12 in a unit cross section may be determined. As is the case with the number Na of protrusions 11, the number Nb of recesses 12 may be e.g. not less than 2 and not more than 10.

In a unit cross section, the number of concave regions 312 in the first surface 31 of the resin layer 30 will be equal to or smaller than the number of protrusions 11, for example. The reason is that there may be cases where deformation of the first electrically-conductive layer 10 toward the resin layer cannot be accommodated. Therefore, the number of concave regions 312 may be e.g. not less than 1 and not more than 10.

### (G) Proportion Lm/L of Length Lm of Inner Surface 10b of First Electrically-Conductive Layer 10

With reference to FIG. 15, the proportion Lm/L of the length Lm of the inner surface 10b of the first electrically-conductive layer 10 will be described. In a unit cross section, the proportion Lm/L of the length Lm of the inner surface 10b of the first electrically-conductive layer 10 relative to the length L (which herein is 2.5 µm) can be used as a parameter representing the degree of meandering of the first electrically-conductive layer 10. As will be described later, in the case where a substantially flat first electrically-conductive layer 10 is to be deformed into the first shape by utilizing the pressuring during the formation of the first material layer 111, the proportion Lm/L of the length Lm may be considered as indicating an elongation rate of the first electrically-conductive layer 10 along the width direction DW.

The length Lm of the inner surface 10b of the first electrically-conductive layer 10 can be calculated by analyzing a unit cross section.

The proportion Lm/L may be e.g. not less than 1.04 and not more than 1.20. When it is 1.04 or more, stress acting on the first electrically-conductive layer 10 from the first material layer 111 can be relaxed more effectively. When it is 1.20 or less, an increase in the resistance of the first electrically-conductive layer 10 associated with the first electrically-conductive layer 10 stretching to become thinner can be suppressed.

### (H) Thickness of the First Electrically-Conductive Layer 10

With reference to FIG. 15, the thickness t of the first electrically-conductive layer 10 will be described. In a unit cross section, the thickness t of the first electrically-conductive layer 10 along the Z direction may be e.g. not less than 0.3 µm and not more than 1.5 µm. The thickness t is an arithmetic mean of distances between the inner surface 10b and the outer surface 10a of the first electrically-conductive layer 10 along the Z direction.

When the thickness t is 0.3 µm or more, resistance of the first electrically-conductive layer 10 can be kept low. If the first electrically-conductive layer 10 is too thick, it is difficult to deform, thus detracting from the effect of relaxing stress from the first material layer 111 through deformation of the first electrically-conductive layer 10 and the resin layer 30. When the thickness of the first electrically-conductive layer 10 is e.g. 1.5 µm or less, the first electrically-conductive layer 10 is easier to deform, thus enhancing the effect of relaxing stress from the first material layer 111 through deformation of the first electrically-conductive layer 10 and the resin layer 30. Furthermore, the entire composite film 100 can be made into a thin film and reduced in weight.

The thickness t of the first electrically-conductive layer 10 may be thinner in the protrusions 11 than in the recesses 12. As illustrated in FIG. 15, in a unit cross section, a thinnest portion t1min of the first electrically-conductive layer 10 may be located at any of the plurality of protrusions 11, for example. Similarly, a thinnest portion t2min of the second electrically-conductive layer 20 may be located at any of the plurality of protrusions 21. The thinnest portions t1min and t2min of the first electrically-conductive layer 10 and the second electrically-conductive layer 20 are preferably 0.3 µm or more, or ½ or more of the thickness tm. As a result of this, lowering of electrical conductivity of the electrically-conductive layer can be suppressed.

### (I) Size and Shape of Gaps G

FIG. 16 is a diagram showing a partial cross section of the first electrode 110A, presenting a schematic representation based on a cross-sectional SEM image. FIG. 17 is a schematic cross-sectional view showing a partial cross section of the first electrode 110A.

As illustrated in FIG. 16 and FIG. 17, as parameters representing the size of each gap g in a unit cross section, a maximum distance (height) hg of the gap g along the Z direction and a maximum length (width) wg of the gap g along the width direction DW can be used. Moreover, as a parameter representing a cross-sectional shape of the gap g, a ratio hg/wg between the height hg and the width wg may be used. In the example shown in FIG. 16, the periphery (contour) of the gap g is defined by the first surface of the resin layer 30 and the inner surface of the first electrically-conductive layer 10. In other words, the gap g is surrounded by the first surface of the resin layer 30 and the inner surface of the first electrically-conductive layer 10. In this case, the height hg of the gap g corresponds to an exfoliation distance of the resin layer 30 and the first electrically-conductive layer 10 along the Z direction, whereas the width wg of the gap g corresponds to an exfoliation distance of the resin layer 30 and the first electrically-conductive layer 10 along the width direction DW.

In a unit cross section, an arithmetic mean of the heights hg of one or more gaps g located between the first electrically-conductive layer 10 and the resin layer 30 may be e.g. greater than 0 but not more than 3 µm. When it is 3 µm or less, the first electrically-conductive layer 10 can be better supported with the resin layer 30, thereby suppressing lowering of electrical conductivity through breaking or bending of portions of the first electrically-conductive layer 10 that are spaced apart from the resin layer 30. Similarly, an arithmetic mean of the heights hg of one or more gaps g located between the second electrically-conductive layer 20 and the resin layer 30 may also be e.g. greater than 0 but not more than 3 µm.

Moreover, in a unit cross section, an arithmetic mean of the ratios hg/wg between the heights hg and the widths wg of one or more gaps g located between the first electrically-conductive layer 10 and the resin layer 30 may be e.g. not less than 1 and not more than 20. When it is 1 or more, internal stress in the first electrically-conductive layer 10 can be relaxed more effectively with the gap(s) g. When it is 20 or less, the first electrically-conductive layer 10 can be better supported with the resin layer 30. Therefore, stress acting on the first electrically-conductive layer 10 can easily be relaxed with the resin layer 30. Similarly, an arithmetic mean of the ratios hg/wg of one or more gaps g located between the second electrically-conductive layer 20 and the resin layer 30 may also be e.g. not less than 1 and not more than 20.

### (J) Proportion of Gaps G

With reference to FIG. 17, the proportion of gaps g will be described. From the standpoint of relaxing stress in the first electrically-conductive layer 10, it is preferable that the proportion of gaps in the composite film 100A, e.g., number density, area ratio of the gaps, or the like as viewed in the Z direction, is equal to or greater than a predetermined value. In the present embodiment, as an alternative parameter to the number density of gaps, the number Ng of recesses 12 that overlap the gaps g along the Z direction among the recesses 12 of the first electrically-conductive layer 10 contained in a unit cross section is used.

In a unit cross section, the first electrically-conductive layer 10 may include one or more recesses 12 such that, among the one or more recesses 12, the number Ng of recesses 12 at least partially overlapping the gaps g along the Z direction is e.g. not less than 1 and not more than 10. When it is 1 or more, internal stress in the first electrically-conductive layer 10 can be relaxed more effectively. When it is 10 or less, the first electrically-conductive layer 10 can be better supported with the resin layer 30, whereby stress acting on the first electrically-conductive layer 10 can be absorbed through deformation of the resin layer 30. Although not particularly limited, the number of gaps g may be not less than 3 and not more than 10.

As illustrated in FIG. 17, in an example where the first electrically-conductive layer 10 and the resin layer 30 are partially in contact (that is, no intervening layer exists between the first electrically-conductive layer 10 and the resin layer 30), the aforementioned number Ng of recesses 12 is the number Ng of recesses 12 that are in contact with the gaps g. The “recesses that are in contact with the gaps” include any recess 12 a part or a whole of which is spaced apart from the first surface 31 of the resin layer 30, such that a gap g is created between the first surface 31 and the recess 12.

In the example shown in FIG. 17, two gaps g are disposed between the first electrically-conductive layer 10 and the resin layer 30. In this example, the number Ng of recesses 12 that are in contact with the gaps g in the first electrically-conductive layer 10 is 3, and the number Ng of recesses 22 that are in contact with the gaps g in the second electrically-conductive layer 20 is 1.

As an alternative parameter to the area ratio of gaps g, a proportion Tw/L of a total Tw of the widths wg along the width direction DW of one or more gaps g included in a unit cross section, relative to the length L of the unit cross section, can be used. Alternatively, a proportion LX/L of a total length LX of the first portions 10X of the first electrically-conductive layer 10 that are in contact with the gaps g, relative to the length L of the unit cross section, may be used. The total length LX is a total of the lengths along the width direction DW of the one or more first portions 10X included in the unit cross section.

The proportion Tw/L and the proportion LX/L are both e.g. not less than 0.02 and not more than 0.5. When it is 0.02 or more, internal stress in the first electrically-conductive layer 10 can be relaxed more effectively. When it is 0.5 or less, the first electrically-conductive layer 10 can be better supported with the resin layer 30, whereby stress acting on the first electrically-conductive layer 10 can be absorbed through deformation of the resin layer 30. Tw/L may be not less than 0.2 and not more than 0.5.

### [Effects]

In a conventional electrode, for example, during a step (e.g., a calendering step) of forming a layer of particles on an electrically-conductive film), and further through expansion/shrinkage of the layer of particles during operation of a power storage device, locally-increased stress may act on the electrically-conductive film, possibly lowering the electrical conductivity of the electrically-conductive film. On the other hand, according to the present embodiment, because a layer of particles is formed on an electrically-conductive layer that is supported on a resin layer, at least a portion of the pressuring by the particles when forming the layer of particles can be absorbed through deformation of the electrically-conductive layer and the resin layer. In a power storage device in which an electrode according to the present embodiment is used, stress acting on the electrically-conductive layer due to expansion/shrinkage of the layer of particles during operation of the power storage device can be absorbed by the electrically-conductive layer having the first shape (or the second shape) and the resin layer. Since the particles in the layer of particles can be received by the protrusions of the electrically-conductive layer that are convexed toward the resin layer, it is possible to restrain locally-increased stress from acting on the electrically-conductive layer. As a result, deterioration of the electrode, e.g., lowering of electrical conductivity of the electrically-conductive layer, can be suppressed.

Furthermore, because of including a gap(s) partially between the electrically-conductive layer and the resin layer, internal stress occurring during the formation of the electrically-conductive layer can be relaxed. As a result, lowering of electrical conductivity of the electrode due to internal stress in the electrically-conductive layer can be suppressed.

Therefore, by using an electrode according to the present embodiment as a positive electrode or a negative electrode of a power storage device such as a secondary battery, the rate characteristics of the power storage device can be improved. Moreover, the reliability of the power storage device can be improved.

### [Method of Producing Electrode]

A method of producing an electrode according to the present embodiment may include, for example: a step (STEP1) of providing a multilayer film including a resin layer and an electrically-conductive layer that is supported on the resin layer; a step (STEP2) of deforming the electrically-conductive layer supported on the resin layer into a predetermined shape; and a step (STEP3) of forming a material layer(s) (which herein is a layer(s) of particles) onto the electrically-conductive layer supported on the resin layer.

STEP2 and STEP3 may be performed concurrently. For example, when forming a layer(s) of particles containing multiple particles on the electrically-conductive layer, as multiple particles pressure the electrically-conductive layer under predetermined conditions, each portion of the electrically-conductive layer that is pressured by a particle(s) can be convexed toward the resin layer. This is presumably because, when the particles pressure the electrically-conductive layer, a local force acts on the electrically-conductive layer in the depth direction; as this local force is absorbed through local deformation of the electrically-conductive layer and the resin layer, the electrically-conductive layer may undergo plastic deformation. The electrically-conductive layer after formation of the layer(s) of particles possesses the first shape (or the second shape) including protrusions corresponding to these particles, for example. At this time, with deformation of the electrically-conductive layer, the surface of the resin layer may also deform. For example, concave regions may be formed on the surface of the resin layer in such a manner as to receive the protrusions of the electrically-conductive layer. When the resin layer cannot sufficiently accommodate the deformation of the electrically-conductive layer, gaps may occur in portions of the interspace between the electrically-conductive layer and the resin layer surface.

The shape(s) of the electrically-conductive layer(s) and the surface shape of the resin layer can be formed by adjusting various conditions. Conditions for adjusting the shape of an electrically-conductive layer may include, for example: hardness and thickness of the resin layer, type of electrically-conductive layer (malleability/ductility and thickness, kind of particles in the layer(s) of particles, powder form of the layer (s) of particles, shape and size of the particles after the layer(s) of particles is formed (after pressurizing), and pressurization condition and temperature condition when forming the layer (s) of particles. By adjusting these conditions, an electrically-conductive layer having a predetermined shape is realized.

The type, thickness, main method of forming, etc., of each layer will be described later. In the case where pressurizing (e.g., a calender process) is performed when forming the layer(s) of particles, the pressurization condition may be set so that, for example: if the electrically-conductive layer is an aluminum layer, the line pressure may be set to a range of not less than 5000 N/cm and not more than 30000 N/cm, and the feed speed may be set to a range of not less than 5 m/min and not more than 30 m/min. In the case where the electrically-conductive layer is a copper layer, the line pressure may be set to a range of not less than 600 N/cm and not more than 35000 N/cm, and the feed speed may be set to a range of not less than 5 m/min and not more than 30 m/min. Pressurization of the layer(s) of particles may be conducted at room temperature, or conducted at a temperature of e.g. not less than 30° C. and not more than 80° C. (heat press). By performing heat press, it becomes easier to deform the electrically-conductive layer and the resin layer.

Conventionally, the material and thickness of each layer and the conditions for forming layers of particles have been selected with an emphasis on suppressing deterioration associated with deformation of the current collector during a calender process. The same is also true when a composite film is used as the current collector, and it is presumable that manufacturing conditions that will intentionally deform the electrically-conductive layer are not chosen. On the other hand, in the present embodiment, the material and thickness of each layer and the conditions for forming the layer(s) of particles are purposely set so as to result in conditions that will deform the predetermined shapes of the electrically-conductive layer and the resin layer. Moreover, conditions that will intentionally create gaps inside the electrode may also be set. These condition are related to one another. For example, the appropriate pressurization condition will differ for different thicknesses of the electrically-conductive layer.

By taking the first electrode 110A shown in FIG. 2 as an example, the method of producing an electrode according to the present embodiment will be described more specifically.

First, a multilayer film including the resin layer 30, the first electrically-conductive layer 10, and the second electrically-conductive layer 20 is provided. Herein, the first electrically-conductive layer 10 is formed on the first surface 31 of the resin layer 30, and the second electrically-conductive layer 20 is formed on the second surface 32 of the resin layer 30, thereby providing a multilayer film. Although the methods of forming the first electrically-conductive layer 10 and the second electrically-conductive layer 20 are not particularly limited, for example, vapor deposition, sputtering, electroplating, electroless plating, or the like may be used. Alternatively, metal foils to become the first electrically-conductive layer 10 and the second electrically-conductive layer 20, respective, may be attached onto the first surface 31 and the second surface 32 of the resin layer 30.

As the resin layer 30, a polyethylene terephthalate film may be used, for example. The surfaces of the resin layer 30 may be substantially flat. Alternatively, for enhancing adhesion or like purposes, it may include surface concavities and convexities.

In the case where the first electrode 110A is e.g. a positive electrode of a lithium-ion secondary battery, aluminum films may be used as the first electrically-conductive layer 10 and the second electrically-conductive layer 20, for example. The aluminum films may be formed on opposite surfaces of the resin layer 30 through vapor deposition or the like. When the first electrode 110A is a negative electrode, copper films may be used as the first electrically-conductive layer 10 and the second electrically-conductive layer 20, for example. For example, on opposite surfaces of the resin layer 30, seed layers of nickel-chromium (NiCr) or copper may be formed by sputtering, after which copper films may be formed on the seed layers by electroplating. Thus, a multilayer film, as a precursor of a composite film, is obtained.

FIG. 18 is a diagram showing a cross-sectional shape of a portion of the multilayer film that is obtained by the above method, presenting a schematic representation based on a cross-sectional SEM image. As illustrated in FIG. 18, at this point, the first electrically-conductive layer 10 and the second electrically-conductive layer 20 of the multilayer film 100B do not need to have any curved portions. In this example, the upper face (which herein is the outer surface 10a of the first electrically-conductive layer 10) of the multilayer film and the lower face (which herein is the outer surface 20a of the second electrically-conductive layer 20) of the multilayer film are substantially flat. Note that each electrically-conductive layer may have concavities and convexities reflecting the surface shape of the resin layer 30.

Thereafter, the first material layer 111 (which is a layer of particles) is formed on the upper face of the multilayer film, and the second material layer 112 (which is a layer of particles) is formed on the lower face of the multilayer film. Specifically, first, a slurry containing an active material, a binder, and a solvent is prepared, and the slurry is introduced on the upper face and the lower face of the multilayer film. As the solvent, an organic solvent such as methanol, ethanol, propanol, N-methyl-2-pyrrolidone, or N,N-dimethylformamide, or water, may be used. When introducing the slurry, a doctor blade coater, a slit die coater, a bar coater, or the like may be adopted. Alternatively, screen printing or gravure printing may be adopted in introducing the slurry. At this time, rather than introducing the slurry over the entire multilayer film, a region where the slurry is not introduced is left. After the slurry is introduced to the multilayer film, the solvent in the slurry is removed through drying.

After the slurry layers are dried, the slurry layers are pressurized with a roll press machine or the like. As described above, by appropriately setting conditions such as pressure, temperature, etc., during the pressurizing, the first electrically-conductive layer 10 and the second electrically-conductive layer 20 in the multilayer film are curved. Herein, the portions of the first electrically-conductive layer 10 that are located between the resin layer 30 and the first material layer 111 are curved through pressurizing, so as to be deformed to have the first shape. Similarly, the portions of the second electrically-conductive layer 20 that are located between the resin layer 30 and the second material layer 112 are curved through pressurizing, so as to be deformed to have the second shape. In this manner, the first electrically-conductive layer 10 and the second electrically-conductive layer 20 are deformed, while also forming the first material layer 111 on the first electrically-conductive layer 10 and forming the second material layer 112 on the second electrically-conductive layer 20. Note that the region of the first electrically-conductive layer 10 and the second electrically-conductive layer 20 where the slurry was not introduced does not need to be curved through pressurizing. Any such region may retain a substantially flat surface even after pressurizing.

Thereafter, the multilayer film and the first material layer 111 and the second material layer 112 are cut out into a predetermined shape that includes a region where the slurry has not been introduced, thereby providing the first electrode 110A, which includes the composite film 100 and the material layers 111 and 112 provided on opposite surfaces of the composite film 100. The regions of the multilayer film where the slurry has not been introduced becomes the tab region 100t of the composite film 100A.

A cross section of the first electrode 110A as produced by the above method and before being incorporated into a cell (that is, before being subjected to charging and discharging) was observe with a SEM, which indicated that, unlike the multilayer film 100B shown in FIG. 18 mentioned earlier, the first electrically-conductive layer 10 and the second electrically-conductive layer 20 were curved. Thus it is confirmed that the above method allows the first electrically-conductive layer 10 and the second electrically-conductive layer 20 to be deformed into predetermined shapes, by utilizing the pressuring when forming the material layers (layers of particles).

Although an instance of performing the step (STEP2) of deforming the electrically-conductive layers concurrently with the step (STEP3) of forming the layers of particles was illustrated above, a step of deforming the electrically-conductive layer may be separately performed. For example, after an electrically-conductive layer is formed on the surfaces of the resin layer, the multilayer film including the electrically-conductive layer and the resin layer is processed, thereby deforming the electrically-conductive layer so as to have the first shape (or the second shape). Thereafter, a layer of particles may be formed on the deformed electrically-conductive layer.

### [Configuration of Power Storage Device]

Next, an example configuration of a power storage device in which an electrode according to the present embodiment is used will be described by taking a lithium-ion secondary battery for example.

FIG. 19 is a schematic outer view showing an example configuration of the power storage device, and FIG. 20 is an exploded perspective view depicting a cell out of the power storage device shown in FIG. 19. Herein, a lithium-ion secondary battery called a pouch type or a laminated type is illustrated as the power storage device. Although the illustrated lithium-ion secondary battery is single-layered, it may also be multi-layered, as will be described later. In the illustrated example, a positive electrode, a separator, and a negative electrode constituting the cell are stacked upon one another in the Z direction in the figure.

As shown in FIG. 19, the lithium-ion secondary battery 1001 includes a cell 2001, a pair of leads 250 and 260 that are connected to the cell 2001, an outer body 300 covering the cell 2001, and an electrolyte 290.

The cell 2001 includes a first electrode 110, a second electrode 120, and a first layer 170 disposed between the first electrode 110 and the second electrode 120. For example, the first electrode 110 may be a positive electrode, and the second electrode 120 may be a negative electrode. The first layer 170 may contain an electrically-insulative material, for example, functioning as a separator. In the illustrated example, the cell 2001 is a single-layered cell including one pair of electrodes.

The lead 250 is electrically connected to the first electrode 110 of the cell 2001, whereas the lead 260 is electrically connected to the second electrode 120 of the cell 2001. In this example, inside the outer body 300, the lead 250 is connected to a tab region 100t of a composite film 100 of the first electrode 110, whereas the lead 260 is connected to a tab region 200t of a composite film 200 of the second electrode 120. A portion of the lead 250 and a portion of the lead 260 may be located outside of the outer body 300. The portion of the lead 250 that is taken outside of the outer body 300 functions as a first terminal (which herein is the positive terminal) of the lithium-ion secondary battery 1001 being a power storage device. The portion of lead 260 that is taken outside of the outer body 300 functions as a second terminal (which herein is the negative terminal) of the lithium-ion secondary battery 1001.

Furthermore, the electrolyte 290 is disposed in the inner space of the outer body 300. The electrolyte 290 may be a non-aqueous electrolyte, for example. When a non-aqueous electrolytic solution is adopted as the electrolyte 290, typically, a sealant (e.g., a resin film of polypropylene or the like; not shown in FIG. 19) for preventing leakage of the electrolytic solution is disposed between the outer body 300 and the lead 250, and between the outer body 300 and the lead 260.

The first electrode 110 has the configuration described above with reference to FIG. 1 and FIG. 2. As shown in FIG. 20, the second electrode 120 includes the composite film 200, as does the first electrode 110. The second electrode 120 includes the composite film 200 and a first material layer 211 that is disposed on the composite film 200. The first electrode 110 and the second electrode 120 are disposed so that the first material layer 111 and the first material layer 211 face each other via the first layer 170. In the illustrated example, the first material layer 211 is disposed only on a portion of the composite film 200. The first material layer 211 may function as an active material layer, for example. The composite film 200 includes the tab region 200t, which is located outside of the first material layer 211 (i.e., not overlapping the first material layer 211) along the Z direction. Although an example is illustrated where the composite film 200 capable of functioning as a current collector is adopted as the second electrode 120, the second electrode 120 may alternatively be a metal current collector such as a metal foil.

The second electrode 120 may be similar in structure to the first electrode 110. In other words, the first material layer 211 of the second electrode 120 may be a layer of particles containing multiple particles; and, in a cross section parallel to the Z direction, the electrically-conductive layer of the composite film 200 may have the first shape. Note that the first material layer 211 in the second electrode 120 does not need to be a layer of particles. In a cross section parallel to the Z direction, the electrically-conductive layer of the composite film 200 does not need to have the first shape or the second shape. For example, the second electrode 120 may include a substantially flat inner surface and outer surface. Furthermore, the second electrode 120 may not include a composite film. In this case, the second electrode 120 may include a metal foil functioning as a current collector, and a material layer that is disposed on the metal foil.

### [Example Configuration 2 of Power Storage Device]

FIG. 21 is a schematic outer view showing another example configuration of the power storage device, and FIG. 22 is an exploded perspective view depicting a cell out of the power storage device shown in FIG. 21. Herein, a multi-layered lithium-ion secondary battery is illustrated as the power storage device. Component elements similar to those of lithium-ion secondary battery 1001 show in FIG. 19 and FIG. 20 are denoted by like reference numerals, and their description may conveniently be omitted.

As shown in FIG. 21, the lithium-ion secondary battery 1002 includes a cell 2002, a pair of leads 250 and 260 that are connected to the cell 2002, an outer body 300 covering the cell 2002, and an electrolyte 290.

As shown in FIG. 22, the cell 2002 includes one or more first electrodes 110A, one or more second electrodes 120A, and one or more first layers 170A. In the configuration illustrated in FIG. 22, the first electrode(s) 110A, the second electrode(s) 120A, and the first layer(s) 170A are all in the form of sheets. In the example shown in FIG. 22, the first electrode(s) 110A, the second electrode(s) 120A, and the first layer(s) 170A are stacked upon one another in the Z direction in the figure.

As schematically shown in FIG. 22, the cell 2002 is structured so that the first electrodes 110A and the second electrodes 120A are alternately stacked via the first layers 170A. For example, the first electrodes 110A may be positive electrodes, and the second electrodes 120A may be negative electrodes. The cell 2002 may include 19 first electrodes 110A and 20 second electrodes 120A, for example. In this case, the cell 2002 includes a total of 19 first layers 170A, each being located between a first electrode 110A and a second electrode 120A.

Each first electrode 110A may have the structure describe above with reference to FIG. 9 and FIG. 10. As shown in FIG. 22, each second electrode 120A includes a composite film 200A, as does a first electrode 110A. The second electrode 120A includes a composite film 200A, a first material layer 211 disposed on the upper face of the composite film 200A, and a second material layer 212 disposed on the lower face of the composite film 200A. The first material layer 211 and the second material layer 212 may function as active material layers, for example. The composite film 200A includes a tab region 200At that is located outside of the first material layer 211 and the second material layer 212 (i.e., not overlapping the first material layer 211 and the second material layer 212 along the Z direction) in the XY plane.

Each second electrode 120A may be similar or different in structure to or from the first electrode 110A. In other words, the first material layer 211 and the second material layer 212 of the second electrode 120A may be a layer of particles containing multiple particles; and, in a cross section parallel to the Z direction, the first electrically-conductive layer composite film 200A may have the first shape, and the second electrically-conductive layer may have the second shape. Note that the first material layer 211 and the second material layer 212 of the second electrode 120A do not need to be layers of particles. In a cross section parallel to the Z direction, the first electrically-conductive layer and the second electrically-conductive layer of the composite film 200A may not include curved protrusions, and may have a substantially flat inner surface and outer surface, for example. In the case where a composite film is not adopted as the second electrode 120A, the second electrode 120A may include a metal foil functioning as a current collector, and material layers located on opposite sides of the metal foil.

Each first layer 170A is disposed between a first electrode 110A, and a second electrode 120A that is located closest to that first electrode 110A. The first layer 170A is made of an electrically-insulative material such as a resin, and prevents direct contact between the layer of particles of the first electrode 110A and the layer of particles of the second electrode 120A.

In the example shown in FIG. 22, the lead 250 is electrically connected to the plurality of first electrodes 110A. The lead 260 is electrically connected to the plurality of second electrodes 120A.

Among the plurality of second electrodes 120A, the second electrode 120A that is located in the uppermost layer of the multilayer structure including the first electrodes 110A and the second electrodes 120A may or may not include the first material layer 211 on its upper face as shown in FIG. 22. Similarly, among the plurality of second electrodes 120A, the second electrode 120A that is located in the lowermost layer of the multilayer structure including the first electrodes 110A and the second electrodes 120A may or may not include the second material layer 212 on its lower face.

Note that power storage devices to which an electrode according to the present embodiment is applicable are not limited to lithium-ion secondary batteries. An electrode according to the present embodiment may be suitable used for an electric double layer capacitor or the like, for example.

### [Description of Component Elements]

Hereinafter, by taking the lithium-ion secondary battery 1002 shown in FIG. 21 and the cell 2002 shown in FIG. 22 for example, component elements of a power storage device according to the present embodiment will be described in more detail.

In the lithium-ion secondary battery 1002, either the first electrodes 110A or the second electrodes 120A are positive electrodes, while the others are negative electrodes. Each of the positive electrodes and the negative electrodes may include: a composite film having an electrically-conductive layer provided on the surface of a resin layer; and a material layer supported on the composite film. In the following description, a composite film used for a positive electrode will be referred to as a “positive-electrode composite film”; a resin layer of a positive-electrode composite film as a “positive-electrode resin layer”; electrically-conductive layers (a first electrically-conductive layer and a second electrically-conductive layer) of a positive-electrode composite film as “positive-electrode conductive layers”; and a material layer of a positive electrode as a “positive-electrode material layer”. Similarly, a composite film used for a negative electrode will be referred to as a “negative-electrode composite film”; a resin layer of a negative-electrode composite film as a “negative-electrode resin layer”; electrically-conductive layers (a first electrically-conductive layer and a second electrically-conductive layer) of a negative-electrode composite film as “negative-electrode conductive layers”; and a layer of particles of a negative electrode as a “negative-electrode material layer”.

### Positive-Electrode Composite Film

### Positive-Electrode Resin Layer

The positive-electrode resin layer of a positive-electrode composite film may be a sheet whose base material is a thermoplastic resin, for example. As the base material of the positive-electrode resin layer, polyester-based resins, polyamide-based resins, polyethylene-based resins, polypropylene-based resins, polyolefin-based resins, polystyrene-based resins, phenol resins, polyurethane-based resins, acetal-based resins, cellophane and ethylene vinyl alcohol copolymers (EVOH), polyethylene terephthalate, polystyrene (PS), polyimides, polyvinyl chloride, and the like may be used. Examples of polyolefin-based resins include polyethylene (PE) and polypropylene (PP). The polyolefin-based resin may be an acid-modified polyolefin-based resin. Examples of polyester-based resins include polybutylene terephthalate (PBT) and polyethylene naphthalate. Examples of polyamide-based resins include nylon 6, nylon 66, and polymetaxylene adipamid (MXD6). For example, a uniaxially oriented sheet or a biaxially oriented sheet of polyethylene terephthalate, or a biaxially oriented sheet of polypropylene may suitably be used as the positive-electrode resin layer. In the present embodiment, the resin layer 30 may at least contain one of polyethylene terephthalate, polypropylene, polyamides, polyimides, polyethylene, polystyrene, phenol resins, and epoxy resins, for example.

As the base material of the positive-electrode resin layer, materials similar to separator materials may be adopted. The positive-electrode resin layer may be provided in the form of a laminate film that contains two or more of the aforementioned materials. The positive-electrode resin layer may further contain a fire retardant agent or the like.

The thickness of the positive-electrode resin layer may be e.g. not less than 3 µm and not more than 12 µm. Note that the form of the positive-electrode resin layer is not limited to a resin film. The positive-electrode resin layer may be a nonwoven fabric or a porous film containing a thermoplastic resin. The positive-electrode resin layer may have a single-layered structure, or a multilayer structure including a plurality of layers.

### • Positive-Electrode Conductive Layers

As the material of the positive-electrode conductive layers of the positive-electrode composite film, aluminum, titanium, chromium, stainless steels or nickel, or an alloy containing one or more of these may be used. The positive-electrode conductive layers may be electrically-conductive films containing aluminum, such as aluminum films or aluminum alloy films, for example. As the positive-electrode conductive layers, electrically-conductive films whose main component is aluminum may be used. The notion “as a main component” encompasses the case where the percent content of aluminum in the electrically-conductive film is e.g. 80 weight% or more. This is advantageous because it is easier for the positive-electrode conductive layers to undergo plastic deformation into a predetermined shape by the below-described method. The material of the first electrically-conductive layer disposed on the first surface of the positive-electrode resin layer and the material of the second electrically-conductive layer disposed on the second surface of the positive-electrode resin layer are typically the same, but they may be different from each other.

The positive-electrode conductive layers can be formed through a known semiconductor process. For example, vapor deposition, sputtering, electroplating, electroless plating, or the like may be used. The thickness of each positive-electrode conductive layer may be e.g. not less than 50 nm and not more than 5 µm, and preferably not less than 100 nm and not more than 2 µm. More preferably, it is not less than 0.5 µm and not more than 1 µm. The positive-electrode conductive layers are not limited to single-layered films. One or both of positive-electrode conductive layers may include a plurality of layers. On the surface of a positive-electrode conductive layer, a protection layer or the like for suppressing oxidation may be further formed.

As has been illustrated in FIG. 9, another solid layer (the solid layer 70 illustrated in FIG. 8) may be present between a positive-electrode conductive layer and the positive-electrode resin layer. The solid layer may be an undercoat layer or an anchor coat layer for enhanced bonding of the electrically-conductive material to the resin layer, for example. The undercoat layer or anchor coat layer may be an organic layer, e.g., an acrylic resin or a polyolefin resin, or a metal layer that is formed by a sputtering technique or the like. Providing an undercoat layer gives the effect of further enhancing the bonding of the positive-electrode conductive layer to the positive-electrode resin layer and/or the effect of restraining pinholes from being formed in the positive-electrode conductive layer.

### Positive-Electrode Material Layer

The positive-electrode material layer may contain a material that is capable of occluding and releasing lithium ions as the positive-electrode active material, for example. The content of the positive-electrode active material in the positive-electrode material layer may be e.g. 80 to 97 mass%. The positive-electrode material layer may further contain a binder, a conductivity aid, and the like. An undercoat layer containing carbon may be allowed to be present between the positive-electrode composite film and the positive-electrode material layer.

When the positive-electrode material layer is a layer of particles, the particles p1 (FIG. 5) contained in the layer of particles may be positive-electrode active material particles, or electrically-conductive particles used as a conductivity aid, etc. Preferably, the particles p1 are positive-electrode active material particles.

An average particle size of the positive-electrode active material used for forming the positive-electrode material layer may be e.g. 1 to 10 µm, and the particles may have an aspect ratio of e.g. 1 to 5. Alternatively, such particles may be made into secondary grains (e.g. with a secondary grain size: 10 to 30 µm), and these secondary grains may be used to form the positive-electrode material layer. Depending on the calender process, etc., when forming the positive-electrode material layer, the particles in the positive-electrode active material may be deformed. Some particles may split or crack. Therefore, although depending on the conditions for forming the active material layer, the size of the positive-electrode active material particles contained in the resultant positive-electrode material layer may differ from the aforementioned size of particles. The particle size or shape, etc., of the positive-electrode active material particles in the positive-electrode material layer can be determined through a particle analysis using the aforementioned “A-zou Kun”.

Examples of materials that are capable of occluding and releasing lithium ions are complex metal oxides containing lithium. Examples of such complex metal oxides include: lithium cobaltate (LiCoO₂); lithium nickelate (LiNiO₂); lithium manganate (LiMnO₂); lithium manganese spinel (LiMn₂O₄); lithium vanadium compound (LiV₂O₅); olivine-type LiMPO₄ (where M is one or more elements selected from the group consisting of Co, Ni, Mn, Fe, Mg, Nb, Ti, Al, and Zr or vanadium oxide); lithium titanate (Li₄Ti₅O₁₂); complex metal oxides expressed by the general formula: LiNiₓCo_{y}Mn_{z}MₐO₂ (x+y+z+a=1, 0≦x<1, 0≦y<1, 0≦ z<1, 0≦a<1, where M in the above general formula is one or more elements selected from the group consisting of Al, Mg, Nb, Ti, Cu, Zn, and Cr); complex metal oxides expressed by the general formula: LiNiₓCo_{y}A1_{z}O₂(0.9<x+y+z<1.1); and so on. As the material that is capable of occluding and releasing lithium ions, the positive-electrode material layer may contain polyacetylene, polyaniline, polypyrrole, polythiophene, polyacene, or the like.

As a binder, various known materials may be used. As the binder in the positive-electrode material layer, fluororesins such as polyvinylidene fluoride (PVDF), polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), polychlorotrifluoroethylene (PCTFE), ethylene-chlorotrifluoroethylene copolymer (ECTFE), and polyvinyl fluoride (PVF) can be used.

As the binder, vinylidene fluoride-based fluororubbers may be used. For example, vinylidene fluoride-hexafluoropropylene-based fluororubber (VDF-HFP-based fluororubber), vinylidene fluoride-hexafluoropropylene-tetrafluoroethylene-based fluororubber (VDF-HFP-TFE-based fluororubber), vinylidene fluoride-pentafluoropropylene-based fluororubber (VDF-PFP-based fluororubber), vinylidene fluoride-pentafluoropropylene-tetrafluoroethylene-based fluororubber (VDF-PFP-TFE-based fluororubber), vinylidene fluoride-perfluoromethyl vinyl ether-tetrafluoroethylene-based fluororubber (VDF-PFMVE-TFE-based fluororubber), vinylidene fluoride-chlorotrifluoroethylene-based fluororubber (VDF-CTFE-based fluororubber), or the like may be adopted as the binder in the positive-electrode material layer.

Examples of conductivity aids include carbon materials such as carbon powder and carbon nanotubes. As the carbon powder, carbon black or the like may be adopted. Other examples of conductivity aids in the positive-electrode material layer include: powder of metals such as nickel, stainless steel, or iron; and powder of electrically-conductive oxides such as ITO. Two or more of the aforementioned materials may be mixed and contained in the positive-electrode material layer.

### Negative-Electrode Composite Film

### • Negative-Electrode Resin Layer

As the material of the negative-electrode resin layer of the negative-electrode composite film, materials exemplified as applicable for the positive-electrode resin layer can be adopted. The material of the negative-electrode resin layer and the material of the positive-electrode resin layer are typically the same, but they may be different from each other. The suitable range of thickness of the negative-electrode resin layer may be similar to the range exemplified for the positive-electrode resin layer.

### • Negative-Electrode Conductive Layers

As the material of the negative-electrode conductive layers of the negative-electrode composite film, an electrically-conductive film containing copper, such as a copper film or a copper alloy film may be used, for example. The material of the first electrically-conductive layer disposed on the first surface of the negative-electrode resin layer and the material of the second electrically-conductive layer disposed on the second surface of the negative-electrode resin layer are typically the same, but they may be different from each other.

The negative-electrode conductive layers can be formed through a known semiconductor process. For example, vapor deposition, sputtering, electroplating, electroless plating, or the like may be used. For example, after forming a seed layer of nickel-chromium (NiCr) on the surface of the negative-electrode resin layer by sputtering technique, a copper film may be formed on the seed layer by electroplating, thereby providing a negative-electrode conductive layer. The negative-electrode conductive layers are also not limited to the form of single-layered films. The thickness of the negative-electrode conductive layers may be e.g. not less than 50 nm and not more than 5 µm, and preferably not less than 100 nm and not more than 2 µm. More preferably, it is not less than 0.5 µm and not more than 1 µm. An undercoat layer or the like may be allowed to be present between a negative-electrode conductive layer and the negative-electrode resin layer. A protection layer or the like may be formed on the surface of a negative-electrode conductive layer.

### Negative-Electrode Material Layer

The negative-electrode material layer may contain a material that is capable of occluding and releasing lithium ions as the negative-electrode active material, for example. Similarly to the positive-electrode material layer, the negative-electrode material layer may further contain a binder, a conductivity aid, and the like. An undercoat layer containing carbon may be allowed to be present between the composite film and the negative-electrode material layer.

Examples of materials that are capable of occluding and releasing lithium ions are natural or man-made graphite, carbon nanotubes, non-graphitizable carbons, graphitizable carbons (soft carbons), low-temperature calcined carbons, and other carbon materials. Other examples of materials that can be adopted for the negative-electrode material layer are alkali metals and alkaline earth metals such as metal lithium, and metals such as tin or silicon that can form compounds with metals such as lithium. Silicon-carbon composites are also applicable to the negative-electrode material layer. As a material that is capable of occluding and releasing lithium ions, the negative-electrode material layer may contain particles of oxide-based amorphous compounds (SiOₓ (0<x<2), tin dioxide, etc.), lithium titanate (Li₄Ti₅O₁₂), or the like.

As the binder and the conductivity aid in the negative-electrode material layer, materials which have been exemplified respectively as applicable binders and conductivity aids for the positive-electrode material layer can be adopted. As the binder in the negative-electrode material layer, other than the aforementioned materials, cellulose, styrene-butadiene rubber, ethylene-propylene rubber, polyimide resins, polyamideimide resins, acrylic resins, or the like may also be used.

### Leads 250, 260

The lead 250 and the lead 260 are plate-shaped members made of an electrically-conductive material. Materials for the one of the lead 250 and the lead 260 that is on the positive electrode side may be, for example, aluminum and aluminum alloys, and materials for the lead on the negative electrode side may be, for example, nickel and nickel alloys.

Each of the lead 250 and the lead 260 may be a rectangular conductor plate, for example. The shape of the lead 250 and the lead 260 is not limited to a rectangular plate shape. Various shapes may be adopted, e.g., a shape that appears bent in an L shape when viewed perpendicularly to the XY plane, a shape having a throughhole, or a shape that is bent in the Z direction.

### First Layer 170A

The first layer 170A is an electrically-insulative member which prevents electrical short-circuiting between the first electrode 110A and the second electrode 120A while allowing lithium ions to pass through. The first layer 170A may include a ceramic coat layer on its surface. The ceramic coat layer may have a thickness in the range of e.g. not less than 2 µm and not more than 5 µm. The first layer 170A may have a thickness in the range of e.g. not less than 5 µm and not more than 30 µm. It is more preferable that the first layer 170A has a thickness in the range of not less than 8 µm and not more than 20 µm.

When adopting an electrolytic solution for the electrolyte 290, an electrically-insulative porous material is used as the first layer 170A. Typical examples of such porous materials are: a single-layered film or a multilayer film of polyolefins such as polyethylene or polypropylene; or a nonwoven fabric of at least one kind of fiber selected from the group consisting of cellulose, polyester, polyacrylonitrile, polyimides, polyamides (e.g., aromatic polyamides), polyethylene, and polypropylene. Alternatively, the first layer 170A may be a porous film. The electrolytic solution may be disposed not only between the material layer on the first electrode 110A side and the first layer 170A and between the material layer on the second electrode 120A side and the first layer 170A, but also within cavities in the first layer 170A.

### Electrolyte 290

As the electrolyte 290, for example, a non-aqueous electrolytic solution containing a metal salt such as lithium salt and an organic solvent can be used. As the lithium salt, for example, LiPF₆, LiClO₄, LiBF₄, LiCF₃SO₃, LiCF₃CF₂SO₃, LiC (CF₃SO₂)₃, LiN (CF₃SO₂) ₂, LiN (CF₃CF₂SO₂)₂, LiN (CF₃SO₂) (C₄F₉SO₂), LiN(CF₃CF₂CO)₂, LiBOB, or the like can be used. One of these lithium salts may be used alone, or two or more of them may be mixed. From an ionization degree standpoint, it is preferable that the electrolyte 290 contains LiPF₆.

As the solvent for the electrolyte 290, for example, organic solvents containing cyclic carbonates and chain carbonates can be adopted. Examples of cyclic carbonates adopted for the electrolyte 290 include ethylene carbonate, propylene carbonate, and butylene carbonate. The organic solvent may advantageously at least contain propylene carbonate as a cyclic carbonate. Addition of a chain carbonate lowers the kinematic viscosity of the organic solvent. As a chain carbonate, diethyl carbonate, dimethyl carbonate, or ethylmethyl carbonate can be used. The volume ratio between the cyclic carbonate(s) and the chain carbonate(s) in the non-aqueous solvent is preferably in the range from 1:9 to 1:1. The organic solvent may further contain methyl acetate, ethyl acetate, methyl propionate, ethyl propionate, propyl propionate, γ -butyrolactone, 1,2-dimethoxy ethane, 1,2-diethoxy ethane, or the like.

The concentration of the electrolyte in the non-aqueous electrolytic solution may advantageously be in the range of not less than 0.5 mol/L and not more than 2.0 mol/L. When the electrolyte concentration is 0.5 mol/L or more, the lithium ion concentration within the non-aqueous electrolytic solution will be just enough, and the ion conduction of lithium ions within the non-aqueous electrolytic solution will be suitable, whereby a sufficient capacity is likely to be obtained during charging and discharging. When the electrolyte concentration is 2.0 mol/L or less, the lithium ions in the electrolyte can be adequately coordinated by the solvent, whereby lowering of the ion conduction of lithium ions in the non-aqueous electrolytic solution is suppressed, thus making it easier to obtain a sufficient capacity during charging and discharging.

As the electrolyte 290, a layer of solid electrolyte may also be adopted. As the material of the layer of solid electrolyte, at least one selected from the group consisting of perovskite compounds such as La_{0.5}Li_{0.5}TiO₃, LISICON compounds such as Li₁₄Zn (GeO₄)₄, garnet compounds such as Li₇La₃Zr₂O₁₂, NASICON compounds such as LiZr₂ (PO₄)₃, Li_{1.3}Al_{0.3}Ti_{1.7} (PO₄)₃, and Li_{1.5}Al_{0.5}Ge_{1.5} (PO₄)₃, thio-LISICON compounds such as Li_{3.25}Ge_{0.25}P_{0.75}S₄ and Li₃PS₄, glass compounds such as Li₂S-P₂S₅ and Li₂O—V₂O₅—SiO₂, and phosphate compounds such as Li₃PO₄, Li_{3.5}Si_{0.5}P_{0.5}O₄, and Li_{2.9}PO_{3.3}N_{0.46} can be used.

### Outer Body 300

The outer body 300 is an coating member to retain the cell 2002 and the electrolyte 290 inside. The outer body 300 functions to protect the cell 2002 and the electrolyte 290 from external moisture and the like. In a configuration where an electrolytic solution is used for the electrolyte 290, the outer body 300 also functions to prevent the electrolytic solution from leaking outside.

The outer body 300 may be a multilayer film such that resin films are formed on opposite surfaces of a metal foil, for example. A representative example of a metal foil to be used for a multilayer film as the outer body 300 is an aluminum foil. As the resin to coat the metal foil, a polymer such as polypropylene may be adopted, for example. The material of the resin film to coat the surface of the metal foil on the cell 2002 side (i.e., the inner surface of the outer body 300) and the material of the resin film to coat the opposite surface from the cell 2002 may be the same or different. For example, regarding the surfaces of the metal foil, the surface on the cell 2002 side may be coated with polyethylene, polypropylene, or the like, and the opposite surface may be coated with a resin material that exhibits a higher melting point, e.g., polyethylene terephthalate or polyamides (PA).

Other than a multilayer film, a metal canister or the like may be adopted as the outer body 300. In the case where a metal canister is adopted as the outer body 300, a valve through which to discharge a gas occurring inside may be provided on the canister. Moreover, there may be cases where active material layers are provided on opposite surfaces of each composite film serving as a current collector, together with the positive electrode and the negative electrode. In such a configuration, the active material layers are located outermost on the cell 2002; also, between the cell 2002 and the canister serving as the outer body 300, an electrically-insulative protective member or the like for ensuring electrical insulation may be provided. As the material of such a protective member, materials similar to those for the separator 270 may be adopted.

The outer body 300 may be a coating member of resin that is formed through curing of an epoxy resin or the like. In other words, the outer body 300 may be nothing but a resin that is formed through potting.

### EXAMPLES

### Relationship 1 Between Battery Characteristics and Shape of Electrically-Conductive Layers of Electrode

The relationship between the battery characteristics and the shape of the electrically-conductive layers of the electrode will be studied. Herein, Batteries 1 to 4 are produced, in which a composite film including electrically-conductive layers on opposite surfaces of a resin layer is adopted as the positive electrode. For the negative electrode of each battery, a metal foil is used as the current collector. Next, each battery is subjected to a charge-discharge test to evaluate its rate characteristics. Thereafter, the positive electrode is taken out from each battery, and a cross-sectional observation of the positive electrode is made.

### <Electrode 1>

### (Producing Battery)

For Electrode 1, a composite film is used as the current collector of the positive electrode, and a copper foil is used as the current collector of the negative electrode.

First, a composite film having aluminum films formed as electrically-conductive layers on opposite surfaces of the resin layer is provided. As the resin layer, a sheet of polyethylene terephthalate having a thickness of 6 µm is used. Next, on opposite surfaces of the sheet of polyethylene terephthalate, aluminum films are formed by vapor deposition so as to have a thickness of 0.8 µm to 0.9 µm, whereby a composite film with a thickness of about 8 µm is obtained.

Next, on opposite surfaces of the composite film, layers of positive-electrode active material particles are formed as layers of particles. In the present Example, LiCoO₂(LCO) is used as the positive-electrode active material. For 100 parts by mass of the positive-electrode active material, acetylene black is weighed to 1 to 3 parts by mass as a conductivity aid, and polyvinylidene fluoride (PVDF) is weighed to 1 to 3 parts by mass as a binder; and these are mixed to give a positive-electrode mixture. Then, the positive-electrode mixture is dispersed in N-methyl-2-pyrrolidone to provide a positive-electrode mixture paint which is in paste form. This paint is applied on each of the opposite surfaces of the composite film so that the amount of applied positive-electrode active material is 10 to 20 mg/cm², and is dried at 60 to 100° C., thus forming a layer of positive-electrode active material particles. Note that no layer of positive-electrode active material particles is formed on a portion of the composite film to become a tab region. Thereafter, a roll press is performed to effect pressure forming.

As described above, the conditions of the roll press (temperature, line pressure, feed speed, etc.) are appropriately set so that the first shape as desired is obtained, on the basis of the material and thickness of the electrically-conductive layers, the thickness and softness of the resin layer, etc. The line pressure of the roll press may be set to e.g. 10000 to 30000 N/cm. The temperature of the rollers during the roll press (hereinafter abbreviated as “temperature during the roll press”) may be set to e.g. 25 to 80° C. For Battery 1, the line pressure of the roll press is 25000 N/cm, and the temperature during the roll press is room temperature (e.g. 25° C.). The feed speed is 10 to 20 m/min. Thus, the positive electrode is produced.

Then, the negative electrode is produced. In the present Example, graphite is used as the negative-electrode active material. For 100 parts by mass of the negative-electrode active material, acetylene black is weighed to 0 to 3 parts by mass as a conductivity aid, and styrene-butadiene rubber (SBR) is weighed to 1 to 3 parts by mass as a binder; and these are mixed to give the negative-electrode mixture. Then, the negative-electrode mixture is dispersed in carboxymethyl cellulose aqueous solution (CMC) to provide a negative-electrode mixture paint which is in paste form. This paint is applied to each of the opposite surfaces of an electrolytic copper foil having a thickness of 8 µm so that the amount of negative-electrode active material is 7 to 12 mg/cm², and is dried at 80 to 110° C., thus forming a negative-electrode active material layer. No negative-electrode active material layer is formed on a portion of the copper foil to become a tab region. Then, a roll press is performed to press the negative-electrode active material layer. The conditions of the roll press are: the line pressure is 10000 to 30000 N/cm; and the feed speed is 10 to 20 m/min. Thus, the negative electrode is produced.

Then, the resultant negative electrodes and positive electrodes are alternately stacked via separators of polyethylene having a thickness of 12 µm, whereby a stacked body including six negative electrodes and five positive electrodes is produced. Then, a negative electrode lead of nickel is attached to the tab region of the negative electrode of the stacked body, and a positive electrode lead of aluminum is attached to the tab region of the positive electrode of the stacked body with an ultrasonic welding machine.

Thereafter, the stacked body is inserted in an outer body made of an aluminum laminate film, and the outer body is heat-sealed, except for one place in which to create an opening. A non-aqueous electrolytic solution is injected in the outer body. What is used herein is a non-aqueous electrolytic solution obtained by adding 1 M (mol/L) of LiPF₆ as a lithium salt in a solvent in which EC (ethylene carbonate) /DEC (diethyl carbonate) are blended to a volume ratio of 3:7. Then, the one remaining place is closed with heat sealing under a reduced pressure with a vacuum sealing machine. Thus, a lithium-ion secondary battery as Battery 1 is produced.

### (Measurement of Rate Characteristics)

Then, the resultant battery is subjected to a charging and discharging cycle test to measure rate characteristics.

For Battery 1 produced as above, by using a secondary battery charge-discharge tester (manufactured by HOKUTO DENKO CORPORATION), first, charging is performed until reaching a battery voltage of 4.2 V through constant current charging at a charge rate of 0.2 C (i.e., the current value at which charging is completed in 5 hours when constant current charging is performed at 25° C.). Thereafter, through constant current discharging at a discharge rate of 0.2 C, discharging is performed until reaching a battery voltage of 2.8 V, and thus an initial discharge capacity C₁ is determined.

Then, charging is performed until reaching a battery voltage of 4.2 V through constant current charging at a charge rate of 0.2 C (i.e., the current value at which charging is completed in 5 hours when constant current charging is performed at 25° C.). Thereafter, discharging is performed until reaching a battery voltage of 2.8 V through constant current discharging at a discharge rate of 2 C (i.e., the current value at which charging is completed in 0.5 hours when constant current charging is performed at 25° C.), and thus a 2 C discharge capacity C₂ is determined.

Next, from the initial discharge capacity C₁ and the 2C discharge capacity C₂, 2C rate characteristics are determined according to the following formula.

$$2 \text{C rate characteristics} \left[\%\right] = {\text{C}}_{2} / {\text{C}}_{1} \times 100$$

### (Observation of Positive Electrode Cross Section)

After the characteristic evaluation, the battery is disassembled and the positive electrode is taken out; after it is cleaned with dimethyl carbonate (DMC), the battery is dried. Thereafter, a cross section of the positive electrode is abraded with a milling apparatus, and the resultant observation sample is observed with a SEM. The magnification for observation is 5000 times.

Herein, for the positive electrode of each battery, five observation samples having cross sections in different directions are produced, and the five unit cross sections are observed. The width (length) L of each unit cross section is 25 µm. First, by the aforementioned method, the Z direction of each unit cross section and the top points of protrusions are identified. Then, an image of each unit cross section is analyzed, and for each of the first electrically-conductive layer and the second electrically-conductive layer, the distance H, the number Na of protrusions, and the recess depth d2 are measured. Thereafter, the distance H, the number Na of protrusions, and the distance dm2 (an arithmetic mean of recess depths d2) for the five unit cross sections are determined. Furthermore, from these unit cross sections, the presence/absence of gaps g located between each electrically-conductive layer and the resin layer is examined.

### <Batteries 2 to 4>

Except for the temperature during the roll press when forming the layers of positive-electrode active material particles, Battery 2, Battery 3, and Battery 4 are produced by a similar method to that for Battery 1. The temperature during the roll press is set at 50° C. for Battery 2, 60° C. for Battery 3, and 80° C. for Battery 4. The pressing conditions for Batteries 1 to 4 are indicated in Table 1. Rate characteristics are measured also for Battery 2, Battery 3, and Battery 4 by a similar method to that for Battery 1, and thereafter, a cross section of the positive electrode is observed.

TABLE 1

pressing condition

| | line pressure (N/cm) | temperature (°C) |
|---|---|---|
| Battery 1 | 25000 | 25 |
| Battery 2 | 25000 | 50 |
| Battery 3 | 25000 | 60 |
| Battery 4 | 25000 | 80 |
| Battery 5 | 25000 | 50 |
| Battery 6 | 30000 | 50 |
| Battery 7 | 30000 | 40 |
| Battery 8 | 30000 | 25 |

### (Results)

### • Relationship Between Rate Characteristics and Shape (recess Depth D2) of Electrically-Conductive Layers of Positive Electrode

Through a cross-sectional observation of the positive electrodes of Batteries 1 to 4, it can be seen that, in any of these batteries, no gaps g are formed between the electrically-conductive layers and the resin layer. It is also confirmed that, in each battery, an arithmetic mean of the distances H regarding the five unit cross sections is sufficiently smaller than the thickness T of the resin layer.

Table 2 together shows measurement results of the rate characteristics and measurement results of the distance dm2 of the positive electrode, for Batteries 1 to 4. The distance dm2 shown in Table 2 is a mean value of the recess depths d2 in the first electrically-conductive layer and the second electrically-conductive layer of the positive electrode of each battery.

TABLE 2

| | distance dm2(µm) | rate characteristics (%) |
|---|---|---|
| Battery 1 | 0.18 | 73 |
| Battery 2 | 0.25 | 81 |
| Battery 3 | 0.46 | 82 |
| Battery 4 | 0.71 | 75 |

It is confirmed from Table 2 that Batteries 1 to 4 all have high rate characteristics. It can also be seen that the distances dm2 of the positive electrode of Batteries 1 to 4 become greater as the temperature during the roll press increases.

It can be seen from the results shown in Table 2 that the rate characteristics are improved as the distance dm2 of the positive electrode increases. This is presumably because, as the distance dm2 (i.e., the depth of the recesses in the electrically-conductive layers) increases, the stress acting on the electrically-conductive layers can be reduced more effectively and the lowering of electrical conductivity of the positive electrode can be better suppressed. Conversely, it can be seen that the rate characteristics tend to lower when the distance dm2 exceeds a certain value. This is presumably because the depth of the recesses in the electrically-conductive layers becoming too large relative to the size of the particles detracts from the effect of reducing the aforementioned stress.

### • Results of Observing Positive Electrode

The values of respective parameters as determined through a cross-sectional observation of the positive electrode by taking the positive electrode of Battery 2 as an example are shown in Table 3 and Table 4. Herein, with respect to the one positive electrode used for Battery 2, images of five unit cross sections U2-1 to U2-5 are analyzed. Note that FIG. 15 mentioned above is a line drawing of a SEM image of the unit cross section U2-1 of Battery 2.

TABLE 3

| unit cross sections of Battery 2 | | distance H (µm) | number of pro-trusions Na | number of recesses Nb | recess depth d2 (µm) | | | | |
|---|---|---|---|---|---|---|---|---|---|
| U2-1 | 1st cond. layer | 0.6 | 5 | 4 | 0.27 | 0.47 | 0.33 | 0.31 | |
| | 2nd cond. layer | 0.4 | 3 | 1 | 0.31 | | | | |
| U2-2 | 1st cond. layer | 0.4 | 2 | 1 | 0.21 | | | | |
| | 2nd cond. layer | 0.9 | 5 | 3 | 0.87 | 0.22 | 0.21 | | |
| U2-3 | 1st cond. layer | 0.7 | 5 | 4 | 0.55 | 0.23 | 0.25 | 0.15 | |
| | 2nd cond. layer | 0.5 | 5 | 1 | 0.12 | | | | |
| U2-4 | 1st cond. layer | 0.5 | 6 | 4 | 0.21 | 0.16 | 0.19 | 0.12 | |
| | 2nd cond. layer | 0.3 | 6 | 5 | 0.23 | 0.21 | 0.17 | 0.17 | 0.25 |
| U2-5 | 1st cond. layer | 0.4 | 5 | 3 | 0.23 | 0.23 | 0.12 | | |
| | 2nd cond. layer | 0.3 | 5 | 3 | 0.23 | 0.14 | 0.10 | | |

TABLE 4

| | | | |
|---|---|---|---|
| | entire Battery 2 | 1st conductive layer | 2nd conductive layer |
| distance H (mean value across five unit cross sections) | 0.5 | 0.5 | 0.5 |
| maximum value of distance H | 0.9 | 0.7 | 0.9 |
| number Na of protrusions (mean value) | 2.9 | 3.2 | 2.6 |
| distance dm1 (mean value of d1) | 0.24 | 0.25 | 0.23 |
| maximum value of protrusion height d1 | 0.67 | 0.67 | 0.65 |
| number Nb of recesses (mean value) | 2.9 | 3.2 | 2.6 |
| distance dm2 (mean value of d2) | 0.25 | 0.25 | 0.25 |
| maximum value of recess depth d2 | 0.87 | 0.55 | 0.87 |
| proportion Rg of gaps g | - | | |

### Relationship 2 Between Battery Characteristics and Shape of Electrically-Conductive Layers of Electrode

The relationship between the battery characteristics and the shape of the electrically-conductive layers of the electrode and the shape of gaps g inside the electrode will be studied. Herein, Batteries 5 to 8 are produced, in which a composite film including electrically-conductive layers on opposite surfaces of a resin layer is adopted as the positive electrode. They are different from Batteries 1 to 4 in that the resultant positive electrode includes gaps g between the electrically-conductive layers and the resin layer.

### <Batteries 5 to 8>

Except for the pressing conditions (temperature during the roll press, line pressure of the roll press) when forming the layers of positive-electrode active material particles, Battery 5 to Battery 8 are produced by a similar method to that for Battery 1. For Battery 5, the temperature during the roll press is set at 50° C., and the line pressure is set at 25000 N/cm; for Battery 6, the temperature during the roll press is set at 50° C., and the line pressure is set at 30000 N/cm; for Battery 7, the temperature during the roll press is set at 40° C., and the line pressure is set at 30000 N/cm; and for Battery 8, the temperature during the roll press is set at 25° C., and the line pressure is set at 30000 N/cm. The pressing conditions for Batteries 5 to 8 also together shown in Table 1.

Next, the rate characteristics of the resultant Battery 5 to Battery 8 are measured. The measurement method is similar to the measurement method for Battery 1. After the characteristic evaluation, the battery is disassembled to take out the positive electrode, and by a similar method to that for Battery 1, observation samples of the positive electrode are produced, and a cross section of the positive electrode is observed with a SEM.

Herein, three observation samples having cross sections in different directions are produced, and the three unit cross sections are observed. The width (length) L of each unit cross section is 25 µm.

First, by a similar method to that for Battery 1, the distance H, the number Na of protrusions, and an arithmetic mean of the recess depths d2 for the five unit cross sections are determined for the positive electrode of each battery. Since the positive electrodes of Batteries 5 to 8 include gaps g inside, an analysis of the gaps g is also performed. Specifically, with respect to each unit cross section, for each of the first electrically-conductive layer and the second electrically-conductive layer, a proportion Tw/L of a total width Tw of the gaps g (that is, a proportion LX/L of a total length LX of the first portions that are in contact with the gaps g), and the number Ng of recesses that are in contact with the gaps g are measured; and their arithmetic means across the three unit cross sections are determined. Furthermore, with respect to each unit cross section, the height hg and width wg of each gap g that is located between the first electrically-conductive layer and second electrically-conductive layer and the resin layer are measured, and arithmetic means of the height hg and width wg and hg/wg of the gaps g contained in the three unit cross sections are determined.

### (Results)

### Relationship Between Rate Characteristics and Shape (Distance dm2) of Positive Electrode and Shape of Gaps G

Through a cross-sectional observation of the positive electrodes of Batteries 5 to 8, it is confirmed that gaps g are created between the electrically-conductive layers and the resin layer in all batteries. Also, in each battery, an arithmetic mean of the distances H regarding the three unit cross sections is sufficiently smaller than the thickness T of the resin layer. Furthermore, it can be seen that a mean value of hg/wg of the gaps g may vary depending on the pressing conditions (herein, temperature and line pressure during the roll press). Thus, it is confirmed that hg/wg of the gaps g can be controlled by adjusting the pressing conditions, for example.

Table 5 together shows measurement results of the rate characteristics and measurement results of the distance dm2 and hg/wg, for Batteries 5 to 8. The distance dm2 shown in Table 5 is a mean value of the distances d2 regarding the first electrically-conductive layer and the second electrically-conductive layer of the positive electrode of each battery. The hg/wg shown in Table 5 is a mean value of hg/wg of gaps that are located between the resin layer and the first electrically-conductive layer and the second electrically-conductive layer of the positive electrode of each battery.

TABLE 5

| | distance dm2(µm) | hg/wg of gaps g | rate characteristics (%) |
|---|---|---|---|
| Battery 5 | 0.27 | 9.8 | 81 |
| Battery 6 | 0.25 | 16.7 | 85 |
| Battery 7 | 0.22 | 16.2 | 87 |
| Battery 8 | 0.29 | 28.1 | 82 |

From Table 5, the distances dm2 of Batteries 5 to 8 are similar to the distance dm2 (0.25) of Electrode 2 mentioned above, but the rate characteristics of Batteries 5 to 8 are equal to or better than the rate characteristics (81%) of Battery 2. From this, it is confirmed that providing the gaps g between the electrically-conductive layers and the resin layer can further improve the rate characteristics. This is presumably because internal stress in the electrically-conductive layer is relaxed by the gaps g, thus suppressing an increase in the resistance of the electrode and deterioration due to internal stress.

Among Batteries 5 to 8, Battery 6 and Battery 7 have higher rate characteristics than those of the other batteries. It can be seen from these results that, although the rate characteristics are improved as hg/wg of the gaps g increases, the rate characteristics tend to lower when hg/wg exceeds a certain value. This is presumably because an increased effect of relaxing internal stress in the electrically-conductive layer is obtained as hg/wg (i.e., the proportion of height relative to the gap width) increases. It is also presumably because, once hg/wg becomes too large, the presence of the gaps hinders the stress acting on the electrically-conductive layers from the layer of particles from being absorbed by the resin layer, thereby lowering electrical conductivity of the electrically-conductive layers.

### • Results of Observing Positive Electrode

The values of respective parameters as determined through a cross-sectional observation of the positive electrode by taking the positive electrodes of Battery 6 and Battery 7 as examples are shown in Table 6 and Table 7. Herein, with respect to the one positive electrode used for Battery 6, images of three unit cross sections U6-1 to U6-3 are analyzed. FIG. 23 is a schematic representation where a SEM image of the unit cross section U6-1 of Battery 6 according to Example is expressed in a line drawing. In FIG. 23, the recesses that are in contact with the gaps are indicated with signs g1 to g8.

As shown in Table 6 and Table 7, in both of Battery 6 and Battery 7, the proportion XL/L (corresponding to the proportion of the gaps g) is 0.28 or more, and the number of recesses that are in contact with the gaps relative to the number of all recesses in the electrically-conductive layers of each battery is 0.8 or more. Therefore, it is considered that the presence of gaps whose cross-sectional shape is appropriately controlled at a high proportion (e.g., XL/L being 0.28 or more) can provide particularly outstanding rate characteristics.

TABLE 6

| parameter | entire Battery 6 | 1st conductive layer | 2nd conductive layer |
|---|---|---|---|
| distance H (mean value) | 0.6 | 0.8 | 0.4 |
| maximum value of distance H | 1.0 | 1.0 | 0.4 |
| number Na of protrusions (mean value) | 4.0 | 4.0 | 4.0 |
| distance dm2 (mean value throughout entire battery) | 0.25 | | |
| proportion Tw/L (mean value) | 0.35 | 0.43 | 0.27 |
| number Ng of recesses | 3.0 | 3.0 | 3.0 |
| in contact with gaps (mean value) | | | |
| proportion of Ng relative to total number of recesses (mean value throughout entire battery) | 0.81 | | |
| height hg of gaps (mean value) | 0.18 | 0.25 | 0.13 |
| gap hg/Hh (mean value) | 16.7 | 16.0 | 17.4 |

TABLE 7

| parameter | entire Battery 7 | 1st conductive layer | 2nd conductive layer |
|---|---|---|---|
| distance H (mean value) | 0.5 | 0.5 | 0.5 |
| maximum value of distance H | 0.7 | 0.6 | 0.7 |
| number Na of protrusions (mean value) | 4.5 | 5.0 | 4.0 |
| distance dm2 | 0.22 | | |
| (mean value throughout entire battery) | | | |
| proportion Tw/L (mean value) | 0.28 | 0.30 | 0.25 |
| number Ng of recesses in contact with gaps (mean value) | 4.5 | 5.0 | 4.0 |
| proportion of Ng relative to total number of recesses (mean value throughout entire battery) | 0.87 | | |
| height hg of gaps (mean value) | 0.12 | 0.13 | 0.11 |
| gap hg/Hh (mean value) | 16.2 | 13.4 | 19.9 |

### INDUSTRIAL APPLICABILITY

Electrodes for power storage devices according to embodiments of the present disclosure are useful for power sources of various electronic devices, electric motors, and the like. Power storage devices according to embodiments of the present disclosure are applicable to power sources for vehicles such as bicycles and cars, power sources for communication devices such as smartphones, power sources for various sensors, and power sources for the motive power of Unmanned eXtended Vehicles (UxV), for example.

REFERENCE SIGNS LIST

| | |
|---|---|
| 10: | first electrically-conductive layer |
| 10a: | outer surface of first electrically-conductive layer |
| 10b: | inner surface of first electrically-conductive layer |
| 10X: | first portion of first electrically-conductive layer |
| 11: | protrusion |
| 11a: | top point |
| 12: | recess |
| 12b: | bottom point |
| 20: | second electrically-conductive layer |
| 20a: | outer surface of second electrically-conductive layer |
| 20b: | inner surface of second electrically-conductive layer |
| 21: | protrusion |
| 21a: | top point |
| 22: | recess |
| 22b: | bottom point |
| 30: | resin layer |
| 31: | first surface of resin layer |
| 31S: | reference plane |
| 32: | second surface of resin layer |
| 70: | solid layer |
| 100, 100A, 200, 200A: | composite film |
| 100t, 200t: | tab region |
| 100a: | upper face of composite film |
| 100b: | lower face of composite film |
| 110, 110A: | first electrode |
| 111, 112: | material layer (layer of particles) |
| p1, p2, p3: | particles |
| 120, 120A: | second electrode |
| 170, 170A: | first layer |
| 211, 212: | positive-electrode material layer |
| 250, 260: | lead |
| 290: | electrolyte |
| 300: | outer body |
| 311, 321: | convex region |
| 312, 322: | concave region |
| 1001, 1002: | power storage device (lithium-ion secondary battery) |
| 2001, 2002: | cell |

1. An electrode for power storage devices, the electrode comprising:
a resin layer having a first surface and a second surface that is located on an opposite side from the first surface;
a first electrically-conductive layer that is disposed on the first surface side of the resin layer; and
a first layer of particles that is disposed on an opposite side of the first electrically-conductive layer from the resin layer, wherein,
in a cross section parallel to a thickness direction of the resin layer,
the first electrically-conductive layer has a first shape including a plurality of protrusions that are convexed toward the resin layer and a recess that is disposed between two adjacent protrusions among the plurality of protrusions; and
a distance H along the thickness direction from one of top points of the two adjacent protrusions to a bottom point of the recess is smaller than a thickness of the resin layer.

2. An electrode for power storage devices, the electrode comprising:
a resin layer having a first surface and a second surface that is located on an opposite side from the first surface;
a first electrically-conductive layer that is disposed on the first surface side of the resin layer; and
a first layer of particles that is disposed on an opposite side of the first electrically-conductive layer from the resin layer, wherein,
in a cross section parallel to a thickness direction of the resin layer, the first electrically-conductive layer has a first shape, the first shape being a first wavy shape including a plurality of protrusions that are convexed toward the resin layer, wherein an amplitude of the first wavy shape along the thickness direction is smaller than a thickness of the resin layer.

3. The electrode for power storage devices of claim 1, wherein,
in a cross section parallel to the thickness direction, the first shape of the first electrically-conductive layer includes two recesses that are located on opposite sides of one of the plurality of protrusions; and
at least a portion of particles in the first layer of particles is located between the two recesses.

4. The electrode for power storage devices of claim 1, wherein,
in a cross section parallel to the thickness direction, the first surface of the resin layer includes a plurality of first concave regions; and
at least a portion of one of the plurality of protrusions is located inside each of the plurality of first concave regions.

5. The electrode for power storage devices of claim 1, wherein the first layer of particles contains a plurality of active material particles.

6. The electrode for power storage devices of claim 1, wherein,
in a cross section parallel to the thickness direction,
one or more gaps exist between the first electrically-conductive layer and the first surface of the resin layer; and
each gap is located between two adjacent protrusions among the plurality of protrusions.

7. The electrode for power storage devices of claim 6, wherein,
in a unit cross section parallel to the thickness direction, the unit cross section having a length L of 25 µm along a width direction that is perpendicular to the thickness direction of the resin layer,
the first shape of the first electrically-conductive layer includes a plurality of recesses, each of the plurality of recesses being located between two adjacent protrusions among the plurality of protrusions, and the number of recesses among the plurality of recesses that are in contact with the one or more gaps is not less than 1 and not more than 10.

8. The electrode for power storage devices of claim 6, wherein, in a unit cross section parallel to the thickness direction, the unit cross section having a length L of 25 µm along a width direction that is perpendicular to the thickness direction of the resin layer, a proportion Tw/L of a total Tw of widths wg perpendicular to the thickness direction of the one or more gaps relative to the length L is not less than 0.02 and not more than 0.5.

9. The electrode for power storage devices of claim 1, wherein,
in a cross section parallel to the thickness direction,
the plurality of protrusions of the first electrically-conductive layer include two protrusions that are in contact with the first surface of the resin layer; and
between two protrusions that are in contact with the first surface, the first electrically-conductive layer includes a first portion that is spaced apart from the first surface.

10. The electrode for power storage devices of claim 9, wherein, in a unit cross section parallel to the thickness direction, the unit cross section having a length L of 25 µm along a width direction that is perpendicular to the thickness direction of the resin layer, a proportion LX/L of a total LX of lengths along the width direction of the first portion relative to the length L is not less than 0.02 and not more than 0.5.

11. The electrode for power storage devices of claim 1, wherein, in a unit cross section parallel to the thickness direction, the unit cross section having a length of 25 µm along a width direction that is perpendicular to the thickness direction of the resin layer, the number of said plurality of protrusions is not less than 2 and not more than 10.

12. The electrode for power storage devices of claim 4, wherein, in a unit cross section parallel to the thickness direction, the unit cross section having a length of 25 µm along a width direction that is perpendicular to the thickness direction of the resin layer, the number of said plurality of first concave regions is not less than 1 and not more than 10.

13. The electrode for power storage devices of claim 1, wherein, in a unit cross section parallel to the thickness direction, the unit cross section having a length L of 25 µm along a width direction that is perpendicular to the thickness direction of the resin layer, a proportion Lm/L of a length Lm of a surface of the first electrically-conductive layer on the resin layer side relative to the length L is not less than 1.04 and not more than 1.20.

14. The electrode for power storage devices of claim 1, wherein, in a unit cross section parallel to the thickness direction, the unit cross section having a length L of 25 µm along a width direction that is perpendicular to the thickness direction of the resin layer, a maximum value of a distance d2 between a line segment connecting top points of two adjacent protrusions among the plurality of protrusions and a point of a recess that is located therebetween that is the most distant from the line segment is not less than 0.2 µm and not more than 3.0 µm.

15. The electrode for power storage devices of claim 7, wherein, in the unit cross section, a height hg of each gap taken perpendicular to the thickness direction is greater than 0 but not more than 3 µm.

16. The electrode for power storage devices of claim 7, wherein, in the unit cross section, a ratio wg/hg between a height hg of each gap taken along the thickness direction and a width wg of each gap taken perpendicular to the thickness direction is not less than 1 and not more than 20.

17. The electrode for power storage devices of claim 1, wherein, in a unit cross section parallel to the thickness direction, the unit cross section having a length of 25 µm along a width direction that is perpendicular to the thickness direction of the resin layer, a thinnest portion of the first electrically-conductive layer is located at one of the plurality of protrusions.

18. The electrode for power storage devices of claim 1, wherein, in a cross section parallel to the thickness direction, the distance H is less than ½ of the thickness of the resin layer.

19. The electrode for power storage devices of claim 1, wherein,
the electrode for power storage devices further comprises
a second electrically-conductive layer that is disposed on the second surface side of the resin layer, and
a second layer of particles that is disposed on an opposite side of the second electrically-conductive layer from the resin layer; and,
in a cross section parallel to the thickness direction, the second electrically-conductive layer has a second shape including a plurality of second protrusions that are convexed toward the resin layer.

20. The electrode for power storage devices of claim 19, wherein,
in a cross section parallel to the thickness direction,
regarding the thickness direction, the plurality of second protrusions include a protrusion at least partially overlapping one of the plurality of protrusions in the first shape and a protrusion not overlapping any of the plurality of protrusions.

21. The electrode for power storage devices of claim 1, wherein the first electrically-conductive layer is thinner than the resin layer, a thickness of the first electrically-conductive layer is not less than 0.3 µm and not more than 1.5 µm, and the thickness of the resin layer is not less than 3 µm and not more than 10 µm.

22. The electrode for power storage devices of claim 1, wherein,
the first electrically-conductive layer contains aluminum as a main component; and
the resin layer at least contains one of polyethylene terephthalate, polypropylene, polyamides, polyimides, polyethylene, polystyrene, phenol resins, and epoxy resins.

23. A lithium-ion secondary battery comprising:
a positive electrode;
a negative electrode;
a separator that is disposed between the negative electrode and the positive electrode; and
a non-aqueous electrolyte containing lithium ions, wherein
the positive electrode is the electrode for power storage devices of claim 1.
